(19) United States
(12) Patent Application Publication
(10) Pub. No.: US 2026/0262041 A1
(43) Pub. Date: Sep. 3, 2026

(54) UPLINK MULTIPLE-INPUT MULTIPLE-OUTPUT USING HIGH RESOLUTION PRECODING BASED ON CHANNEL STATE INFORMATION FEEDBACK FROM USER EQUIPMENT

(71) Applicant: QUALCOMM Incorporated, San Diego, CA (US)

(72) Inventors: Hyojin LEE, San Diego, CA (US); Yu ZHANG, San Diego, CA (US); Jing SUN, San Diego, CA (US); Jing JIANG, San Diego, CA (US)

(21) Appl. No.: 19/067,819

(22) Filed: Feb. 28, 2025

(51) Int. Cl. H04W 72/21; H04B 7/06

(52) U.S. Cl. CPC H04W 72/21; H04B 7/0626; H04B 7/0639; H04B 7/06968

(57) ABSTRACT

Certain aspects of the present disclosure provide techniques for wireless communications. An example method includes obtaining, from a network entity, a channel state information reference signal (CSI-RS); transmitting, to the network entity, uplink precoding information that identifies a precoder that is based on the CSI-RS; obtaining, from the network entity, an uplink grant that indicates a selected precoder; and transmitting, to the network entity, a first physical uplink shared channel (PUSCH) using the selected precoder.

### INTRODUCTION

### Field of the Disclosure

Aspects of the present disclosure relate to wireless communications, and more particularly, to techniques for performing an uplink (UL) multiple-input and multiple-output (MIMO) procedure using high resolution precoding based on channel state information (CSI) feedback from user equipment (UE).

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining, from a network entity, a channel state information reference signal (CSI-RS); transmitting, to the network entity, uplink precoding information that identifies a precoder that is based on the CSI-RS; obtaining, from the network entity, an uplink grant that indicates a selected precoder; and transmitting, to the network entity, a first physical uplink shared channel (PUSCH) using the selected precoder.

Certain aspects provide a method for wireless communications by a network entity. The method includes transmitting a CSI-RS; obtaining uplink precoding information that identifies a precoder that is based on the CSI-RS; transmitting an uplink grant that indicates a selected precoder; and obtaining a first PUSCH using the selected precoder.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for closed-loop feedback associated with a communications channel between a network entity and a UE.

FIG. 6 illustrates a matrix notation of an example precoding feedback codebook.

FIG. 7 illustrates an example precoding architecture for communications channels between a network entity and a UE.

FIG. 8 depicts a process flow for communications in a network between a network entity and a UE.

FIG. 9 depicts a method for wireless communications.

FIG. 10 depicts another method for wireless communications.

FIG. 11 depicts aspects of an example communications device.

FIG. 12 depicts aspects of an example communications device.

FIG. 13 depicts an example of a table of precoding matrix indicator (PMI) payload size for downlink (DL) Type-I single-panel codebook.

FIG. 14 depicts an example of a table of PMI payload size for DL Type-II codebook.

### DETAILED DESCRIPTION

Aspects of the present disclosure provide apparatuses, methods, processing systems, and computer-readable mediums for performing an uplink (UL) multiple-input and multiple-output (MIMO) procedure using high resolution precoding based on channel state information (CSI) feedback from user equipment (UE).

In certain wireless communications systems, such as 5G New Radio (NR) systems and/or future wireless communications technologies, closed-loop feedback associated with a communications channel may be used to dynamically adapt communications link parameters (e.g., modulation and coding scheme, beamforming, MIMO layers, etc.) according to time varying channel conditions, for example, due to changes with respect to UE mobility, weather conditions, scattering, fading, interference, noise, etc. A UE may provide a CSI report (which may be referred to as a channel state feedback (CSF) or CSI feedback, or the CSI included in which may be referred to as a CSF) to a network entity (e.g., a base station), which may adjust certain communications link parameters in response to the CSF from the UE. The CSI report includes CSI (e.g., determined by the UE). For example, the CSI includes layer indicator, rank indicator, etc. The CSI is based on a channel matrix that is derived from measuring the channel. Link adaptation (such as adaptive modulation and coding) with various modulation schemes and channel coding rates may be applied to certain communications channels.

As an example, a UE may measure a reference signal and estimate the channel state based on measurements of that reference signal. The UE may report an estimated channel state to the network entity in the form of CSF. In certain cases, the CSF may indicate channel properties of a communications link between the network entity and the UE. For example, the CSF may indicate the effect of, for example, scattering, fading, and pathloss of a signal propagating across the communications link. In some cases, the CSF may indicate the UE's preferred precoding for MIMO and/or beamformed communications, for example, in the form of a precoding feedback (e.g., a precoding matrix indicator (PMI)). As an example, the CSF (e.g., a CSI report) may include a channel quality indicator (CQI), PMI, a layer indicator (LI), a rank indicator (RI), a reference signal received power (RSRP), a signal-to-interference-plus-noise ratio (SINR), etc. Additional or other information may be included in the CSF.

In certain wireless communications systems, a UE may perform a UL MIMO procedure in one or more ways. MIMO refers to using multiple antennas to increase wireless data transfer rates. For example, in MIMO, a wireless communications device may use multiple antennas to transmit multiple data streams. One form of MIMO is UL MIMO, in which a UE transmits an uplink communication using MIMO. An example of the UL MIMO procedure may be a codebook-based UL MIMO. For the codebook-based UL MIMO, the UE may transmit a sounding reference signal (SRS) to a network entity (e.g., base station). The network entity may measure the SRS and derive a precoding and a modulation and coding scheme (MCS) based on measuring the SRS. The precoding refers to a beamforming scheme to support multi-layer transmission of a signal in a MIMO system. The network entity may transmit a UL grant that indicates (1) the MCS and (2) a transmitted precoding matrix indicator (TPMI) that indicates the precoding. The UE may transmit a physical uplink shared channel (PUSCH) in accordance with the UL grant.

Another example of the UL MIMO procedure may be a non-codebook-based UL MIMO. For the non-codebook-based MIMO, a network entity may transmit a channel state information reference signal (CSI-RS). A UE may obtain the CSI-RS and derive a precoding based on the CSI-RS. The UE may transmit an SRS in accordance with the derived precoding. The network entity may measure the SRS and derive a rank (e.g., a column selection, such as a number of MIMO layers that the wireless channel can support) and an MCS based on the SRS. The network entity may transmit a UL grant indicating an SRS resource indicator (SRI) and the MCS. The SRI may indicate the SRS, such that the UE can identify a precoding that was selected by the network entity (based on the SRS indicated by the SRI having been transmitted with the precoding). The UE may obtain the UL grant and transmit a PUSCH in accordance with the UL grant.

Certain technical problems exist for the codebook-based UL MIMO and for the non-codebook-based UL MIMO. Technical problems for the codebook-based UL MIMO may include, for example, how to achieve efficient indication of TPMI in a UL grant, which precludes a high resolution precoding (e.g., supporting one or more subbands). For example, if a high resolution precoding were to be supported for the UL grant, the size of the TPMI would increase proportionally to the number of subbands. Thus, if a downlink control information (DCI) were to support such large size of the TPMI for a high resolution precoding, the size of the DCI would be too large to guarantee a physical downlink control channel (PDCCH) coverage. Accordingly, only a low resolution precoding (e.g., only supporting wideband) may be supported for the codebook-based UL MIMO. When compared to being able to support a high resolution precoding, supporting only the low resolution precoding may result in a reduced UL throughput due to diminished beamforming performance or responsiveness to subband-granularity channel variation.

Technical problems for the non-codebook-based UL MIMO may include, for example, an operational latency associated with a three-way operation, such as in (1) a network entity transmitting a CSI-RS, (2) a UE transmitting a precoded SRS (e.g., based on a precoding derived from the CSI-RS), and (3) the network entity transmitting a UL grant indicating a selected precoder (e.g., based on the precoded SRS) via an SRI. A latency associated with such three-way operation may include, for example, a CSI-RS period, an SRS period, a network entity scheduling latency, and a PUSCH processing time. In certain cases, such latency associated with the non-codebook-based UL MIMO may be as great as hundreds of milliseconds (ms), potentially resulting in an unwanted length of delay.

Aspects described herein may overcome the aforementioned technical problems, for example, by providing a UL MIMO scheme that utilizes a high resolution precoding based on CSI-RS measurements. For example, a UE may obtain a CSI-RS and report a high resolution precoding for UL based on CSI-RS measurements. This differs from the codebook-based UL MIMO or the non-codebook-based UL MIMO described above in that the UE is explicitly reporting the high resolution precoding (or information derived from the high resolution precoding) instead of transmitting an SRS from which a network entity derives the precoding. Furthermore, the precoding is a high resolution precoding, which may be based on a high resolution codebook. The high resolution codebook may include a higher number or granularity of precoding matrices than a low resolution codebook (e.g., used for the codebook-based UL MIMO described above). For example, the number of precoding matrices defined or indicated by the high resolution codebook may be identified or indicated based on hundreds of bits or more, while the number of precoding matrices defined or indicated by the low resolution codebook may be identified or indicated based on less than ten bits (e.g., 5 bits). The higher number of precoding matrices of the high resolution codebook may enable a definition or indication of precoding for each of a plurality of subbands, thereby enabling a greater flexibility in how to shape the signals for UL MIMO. For example, a high resolution codebook for UL MIMO may be similar to a high resolution codebook for a downlink (DL) MIMO, such as a DL Enhanced Type-II (eType-II) codebook, which may allow application of a unique precoding for each of a plurality of subbands.

In certain aspects, there may be a UL and DL reciprocity, where radio conditions may be essentially the same or similar for UL and DL (e.g., where UL channel conditions can be inferred from measurements of DL signals, or vice versa). In some aspects, the UE may transmit, to a network entity, an SRS which is associated with the CSI-RS, where the association means that the same antenna ports for SRS transmission and reception are used for CSI-RS reception and transmission in the UE and the network entity, respectively. This SRS may enable the network entity to determine UL channel conditions or characteristics, such as relating to any uplink interference, etc. The network entity may schedule and transmit a UL grant based on the SRS and the reported high resolution precoding for UL (e.g., based on the CSI-RS measurements by the UE). The UL grant may include a precoding indication for the UE to apply the most recently reported high resolution precoding matrix for a PUSCH.

Certain techniques for performing a UL MIMO procedure using high resolution precoding based on CSI feedback from UE as described herein may provide various beneficial technical effects and/or advantages. The techniques for performing a UL MIMO procedure using high resolution precoding based on CSI feedback from UE may enable improved wireless communications performance, such as an increased precoding gain that comes from a reduced channel acquisition delay. The improved wireless communications performance, including the larger precoding gain, may be attributable to one or more of the following. For example, a report of a high resolution precoding described herein may use less UL overhead than a non-codebook-based SRS. For example, the non-codebook-based SRS (e.g., a precoded SRS) may use an entire UL bandwidth, while the report of the high resolution precoding may use less UL overhead (e.g., 10 or 20 resource blocks). Thus, a shorter periodicity may be feasible for such report of a high resolution precoding (e.g., based on using less overhead), which may result in a reduced channel acquisition latency. As another example, a report of a high resolution precoding described herein may result in a network entity acquiring a full bandwidth channel information with a reduced delay when compared to a non-codebook-based SRS applying a frequency hopping. For example, the extent of the benefit from applying a frequency hopping may be greater for the report of the high resolution precoding when compared to applying a frequency hopping for the non-codebook-based SRS.

Moreover, a CSI report (e.g., based on a CSI-RS) may be more reliable than a CSI acquisition based on a non-codebook-based SRS. For example, in certain cases, CSI-RS measurements may be more reliable than SRS measurements based on signal-to-noise ratio (SNR), etc. Thus, a precoding based on CSI-RS measurements (of certain aspects of the present disclosure) may be more reliable than a precoding based on SRS measurements (of the codebook-based UL MIMO or the non-codebook-based UL MIMO described above). Further, uplink control information (UCI) for reporting a high resolution precoding may have a larger multi-user multiplexing capacity than an SRS which relies on comb-based multiplexing. For example, the high resolution precoding may be reported via a physical uplink control channel (PUCCH) or a UCI on a PUSCH. Thus, the overhead associated with reporting a high resolution precoding may be reduced (e.g., when compared to transmitting a precoded SRS), thereby reducing an overall CSI acquisition latency for UL MIMO using a high resolution precoding. Also, a DL CSI reporting framework may be re-used without defining a new type of DL or UL control channel for an indication of a high resolution precoding. Lastly, a UE does not need to support precoded non-codebook-based SRS resources. For example, a single type of SRS resources (e.g., non-precoded resources) may be sufficient for a high resolution precoding.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

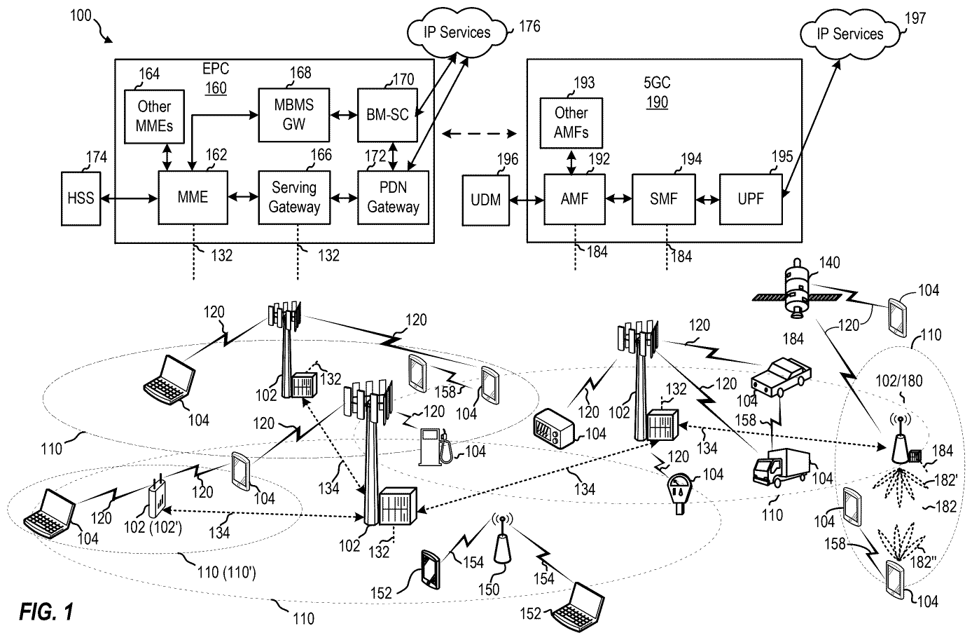

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communications coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

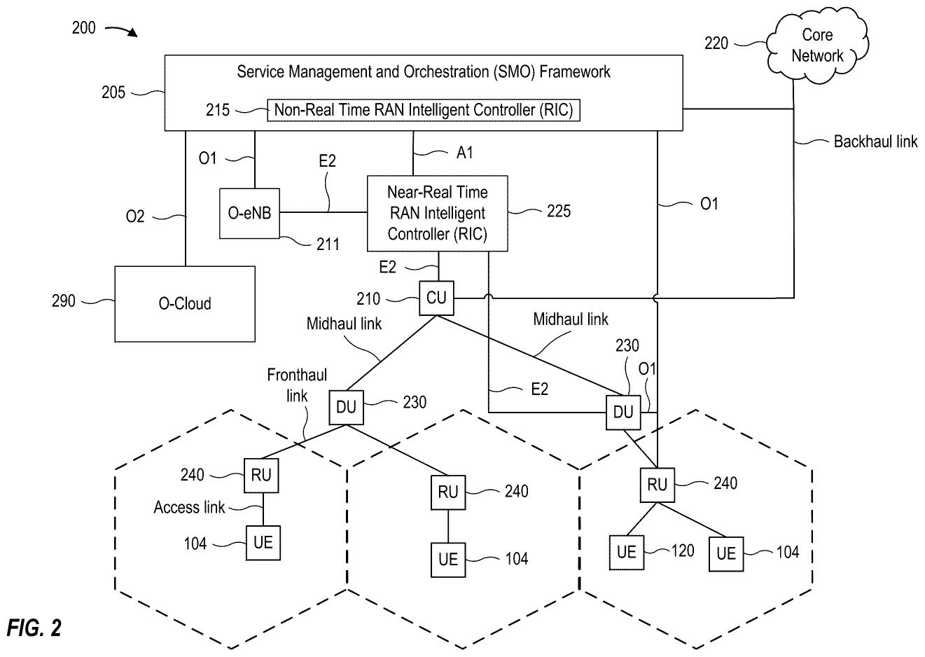

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

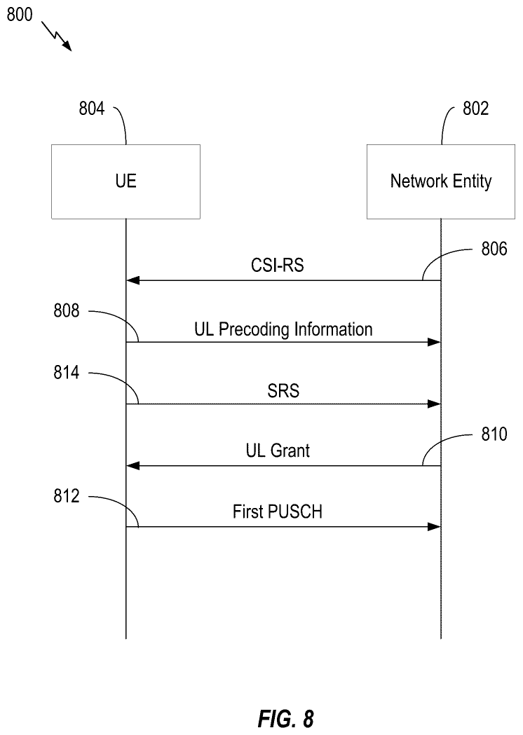

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range. This beamforming may be based on high resolution precoding based on CSI feedback from the UE, such as the high resolution precoding described herein with respect to, for example, FIG. 8. This high resolution precoding may be based on a high resolution codebook, which includes a high number or granularity of precoding matrices as described herein.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communications link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

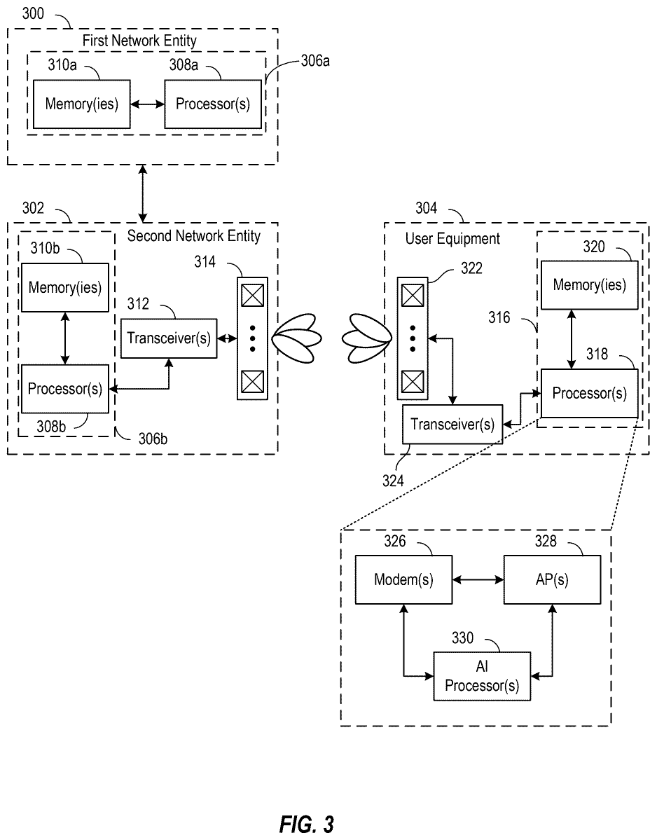

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302. The precoding, such as for the symbols for the transmission of the PUSCH, may be high resolution precoding based on CSI feedback from a UE, such as the high resolution precoding described herein with respect to, for example, FIG. 8. This high resolution precoding may be based on a high resolution codebook, which includes a high number or granularity of precoding matrices as described herein.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communications device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

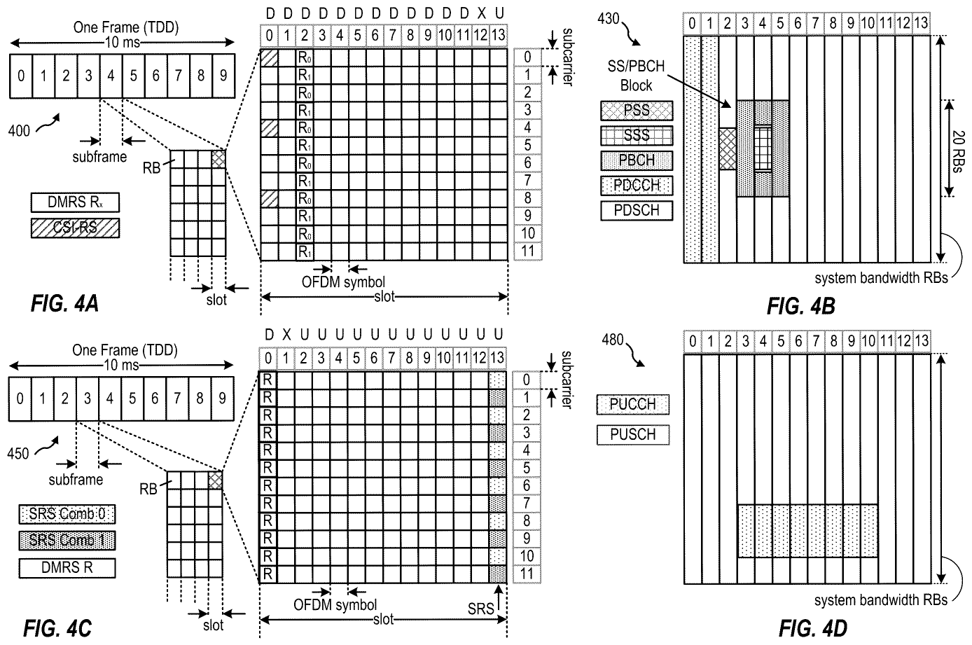

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 24× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Channel State Feedback

In certain wireless communications systems, closed-loop feedback associated with a communications channel may be used to dynamically adapt communications link parameters to channel conditions that may change over time. In some cases, a UE may receive a reference signal (e.g., SSB, CSI-RS, DM-RS, etc.) from a network entity (or another UE) and report channel state feedback to the network entity (or the other UE), where the channel state feedback is determined based on measurements of the reference signal received at the UE. In certain cases, a UE may transmit a reference signal (e.g., SSB, CSI-RS, DM-RS, PT-RS, SRS, etc.), and a network entity (or another UE) may determine characteristics associated with the channel based on measurements of the received reference signal.

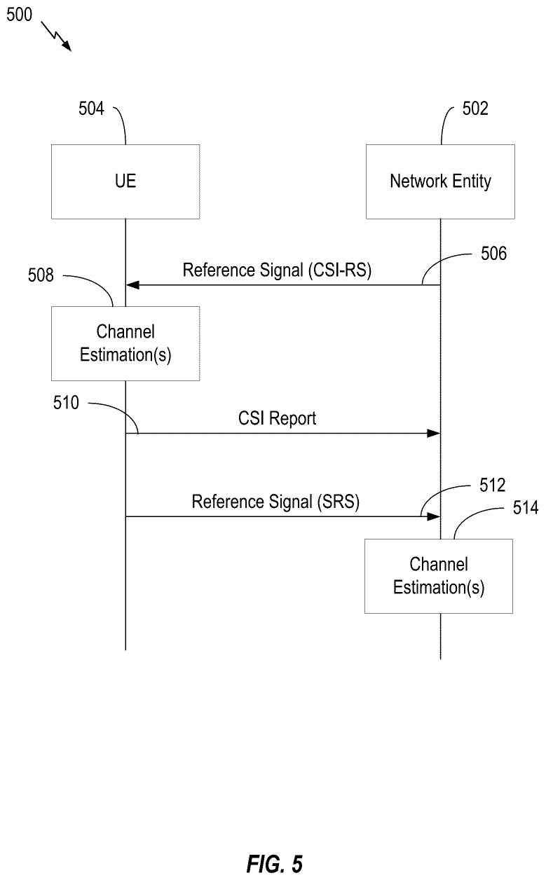

FIG. 5 depicts a process flow 500 for closed-loop feedback associated with a communications channel between a network entity 502 and a UE 504.

At 506, the UE 504 receives a reference signal (e.g., SSB, CSI-RS, etc.) from the network entity 502.

At 508, the UE 504 performs channel calculations based on the reference signal, such as determining a channel estimate H based on the received reference signal. For example, the UE 504 may include a demodulator, which may be part of a transceiver (e.g., transceiver 354 of FIG. 3), RX MIMO detector (e.g., RX MIMO detector 356 of FIG. 3), and/or receive processor (e.g., receive processor 358 of FIG. 3) of UE 504. The demodulator, such as a component of the demodulator, may take as input the reference signal as received over multiple antennas of the UE 504 and output a vector y that is a representation of the received reference signal as received over each of the multiple antennas of the UE 504.

Based on a received signal model, the vector y can be represented as follows in equation (1):

$$\vec{y} = H \vec{x} + \vec{n} \qquad ( 1 )$$

In equation (1), H corresponds to a matrix representation of the communications channel, as in a channel estimate of the communications channel the signal is communicated in (e.g., downlink communications channel where the reference signal is communicated), \vec{x} is the vector representing symbols transmitted by network entity 502 over a number of spatial layers, and \vec{n} is noise across the communications channel. In certain aspects, H has a size equal to the number of antennas used to receive the signaling, Nₐₙₜ, times the number of spatial layers, Nₗ, (e.g., the number of beamformed transmissions, number of antenna ports, etc.). For example, H has a number of rows equal to Nₐₙₜ and a number of columns equal to Nₗ. In certain aspects, the symbols that form the reference signal are known by the UE 504 (e.g., configured or preconfigured at the UE). UE 504 can determine the channel estimate H based on receiving the reference signal.

In certain aspects, UE 504 may further calculate, as part of the channel calculations, a precoder (e.g., precoder matrix) V based on the channel estimate H. For example, UE 504 may be configured to perform singular value decomposition (SVD) based precoding to determine the precoder V. For example, SVD(H)=[U S V], such that SVD provides the precoder V. U may be related to the ordering of the rows of H, as in the ordering of the antennas as represented by H. It should be understood that other suitable techniques may be used to determine the precoder V based on the channel estimate H.

At 510, UE 504 sends to network entity 502 a CSI report indicating the determined channel estimate H and/or precoder V. For example, the UE may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V) to apply to downlink transmissions. In certain aspects, the PMI may indicate the UE's preferred precoding for the downlink transmissions on the PDSCH. CQI may be an indicator of channel quality, such as corresponding to H. The UE 504 may send an indication of the one or more determined CSI parameters to the network entity 502 in the CSI report. The network entity 502 may schedule downlink data transmissions to the UE 504 accordingly, such as using a modulation scheme, code rate, number of transmission layers, etc., that the network entity determines based on the CSI report.

At 512, UE 504 sends a reference signal (e.g., SSB, CSI-RS, DM-RS, PT-RS, SRS, etc.) to the network entity 502.

At 514, the network entity 502 performs channel calculations based on the reference signal, such as determining a channel estimate H based on the received reference signal, for example, as described herein with respect to the UE performing channel calculations at 508.

In certain aspects, network entity 502 may further calculate, as part of the channel calculations, a precoder (e.g., precoder matrix) V based on the channel estimate H, for example, as described herein with respect to the UE 504 performing such a calculation. Accordingly, the network entity 502 may determine H and/or V for an uplink channel between UE 604 and network entity 502 based on SRS. Further, as discussed, the uplink channel between UE 504 and network entity 502 may have reciprocity with a downlink channel between UE 504 and network entity 502. Accordingly, the determined values of H and/or V for the uplink channel between UE 504 and network entity 502 may be used for the downlink channel between UE 504 and network entity 502. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 502 may apply a function to H and/or V determined for the uplink channel.

### Aspects Related to Precoding Feedback

In certain aspects, precoding feedback described herein may be indicated via a precoding codebook. A precoding codebook may define the matrix notation for reporting the preferred precoding for one or more beams, for example, in the context of gains and phase shifts applied across antenna elements that form certain beams. Certain wireless communications systems (e.g., 5G NR or any future wireless communications system) may define the precoding codebooks used for precoding feedback. As an example, 5G NR systems may use Type-I codebooks, Type-II codebooks, and Type-II port selection codebooks.

The Type-I codebooks are primarily used for single-user MIMO (SU-MIMO) with support for high order and low order MIMO transmissions (e.g., 8×8, 4×4, and 2×2 MIMO). The Type-I codebooks may be used in line-of-sight scenarios for the communications link between the UE and the network entity. The Type-I codebooks may include single panel and multi-panel codebooks, where single panel and multi-panel refer to the number of transmission panels used at the network entity.

The Type-II codebooks are used for multi-user MIMO (MU-MIMO) with support for up to two MIMO layers. The Type-II codebooks may provide more accurate channel state information with respect to the Type-I codebooks. The Type-II codebooks may include a Type-II codebook, an Enhanced Type-II codebook, a Type-II Doppler codebook, and a Type-II coherent joint transmission (CJT) codebook.

The Type-II port selection codebooks are used for obtaining refined precoding feedback relative to the Type-I and Type-II codebooks. The Type-II port selection codebooks use reference signals that have been beamformed at the network entity, for example, where the network entity has some knowledge of the communications channel between the UE and the network entity (e.g., knowledge derived from reporting in accordance with one of the other precoding codebooks, such as the Type-I and Type-II codebooks). The Type-II port selection codebooks may include a Type-II port selection codebook, an Enhanced Type-II Port Selection codebook, and a Further Enhanced Type-II Port Selection codebook. The Type-II codebooks and the Type-II port selection codebooks may be used in multi-path channels. The Enhanced Type-II Port Selection codebook and the Further Enhanced Type-II Port Selection codebook, such as defined within 3rd Generation Partnership Project (3GPP) Technical Specification (TS) 38.214, version 18.5.0, Section 5.2.2.2, may be used for spatial and frequency sparsity.

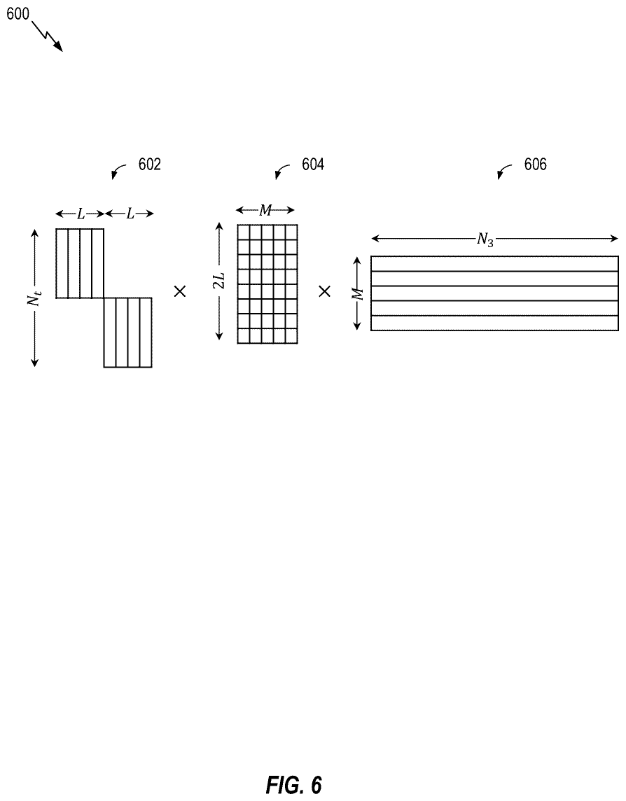

FIG. 6 illustrates a matrix notation 600 of an example precoding feedback codebook, for example, an Enhanced Type-II codebook. The Enhanced Type-II codebook supports up to rank 4 precoding feedback with reduced overhead using a compression technique. In this example, a precoder matrix W⁽ [symbol] ⁾ for a particular layer ( [symbol] ) may be given by the following expression:

$${W}^{( ℓ )} = {W}_{1} {W}_{2 , ℓ} {W}_{f , ℓ}^{H}$$

where W₁ is a wideband spatial domain (SD) basis (e.g., a beam matrix 602); [symbol] is a coefficient matrix 604 comprising subband phases and subband amplitudes; and

$${W}_{f , ℓ}^{H}$$

is a delay matrix 606 (e.g., a frequency domain (FD) basis) comprising delay information that maps phase information of the N₃ subbands to the M basis vectors. The precoder matrix W⁽ [symbol] ⁾ has a size of Nₜ×N₃, where Nₜ is the number of transmit antenna elements (which may include physical or logical antenna elements), N₃ is the number of subbands being reported and determined by a number of CQI subbands and the number of PMI subbands per CQI subband.

The beam matrix 602 (W₁) is a block-diagonal matrix having a size of Nₜ×2L and may be the same for all layers (e.g., layer common), where L is the number of beams being reported and may be configured via control signaling. The coefficient matrix 604 ( [symbol] ) has a size of 2L×M and is specific to each layer (e.g., layer specific), where M is the number of basis vectors in the frequency domain. M may be configured via control signaling and based on the rank indicator (RI). The UE may be configured with a parameter (K₀) that defines the maximum number of non-zero coefficients that can be reported across all layers. The delay matrix 606

$$( {W}_{f , ℓ}^{H} )$$

has a size of M×N₃ and is specific to each layer (e.g., layer specific).

One difference between port selection codebooks and non-port selection codebooks (e.g., Type-I codebooks and Type-II codebooks) is in the beam selection mechanisms. In the non-port selection codebooks, the UE indicates spatial beams via CSI reporting, for example, as part of the beam matrix W₁. For example, the UE generates intermediate candidate beams using spatial oversampling between spatially separated orthogonal beams, and the UE may select one or more strong beams among the candidate beams based on CSI. In port selection codebooks, the network entity transmits precoded reference signals with different precoders, where each precoder represents a particular beam and is associated with an antenna port. The UE selects several antenna ports by measurements of the corresponding reference signals and reports the coefficients. Thus, the beams are determined by antenna port selection. In FR2, the UE may indicate spatial beams during certain beam management operations, and codebooks may generally be thought of as port selection codebooks. Port selection codebooks may provide lower complexity and improved scaling for UE antenna array sizes.

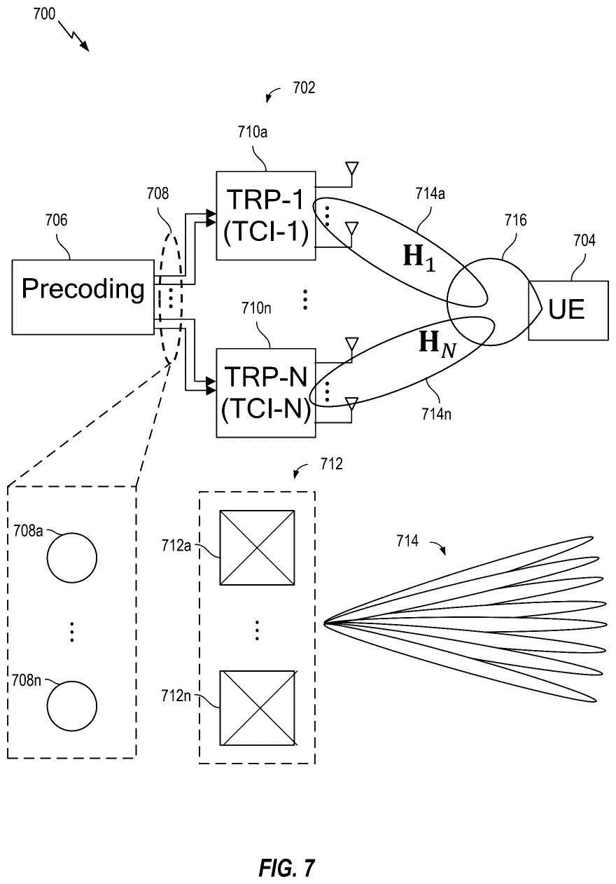

FIG. 7 illustrates an example precoding architecture 700 for communications channels between a network entity 702 and a UE 704. In this example, the network entity 702 may perform precoding 706 (e.g., digital precoding) for beamformed communications. For digital precoding, the network entity 702 may generate different signals having different phases and/or powers in the digital domain for each antenna element to form a beamformed transmission of a precoded signal, which may be associated with a precoding antenna port (e.g., a CSI-RS antenna port) among a pool of antenna ports 708a-n (collectively the antenna ports 708). A precoding antenna port (e.g., the antenna port 708) may correspond to one or more antenna elements used to form a beam (e.g., the transmit beam 714a) on a given communications channel (e.g., H₁) between the network entity 702 and the UE 704.

In certain cases, the network entity 702 may include a plurality of transmission-reception points (TRPs) 710a-n. A TRP may be or include an antenna panel having a plurality of antenna elements 712a-n (collectively the antenna elements 712), for example, arranged in an array. In some cases, the antenna elements 712 may include cross-polar antenna elements. The antenna elements 712 may be used to form various transmit beams 714, where each of the transmit beams 714 may correspond to a specific precoding antenna port among the antenna ports 708. For example, the first precoding antenna port 708a may correspond to the first transmit beam 714a formed via the first TRP 710a, and the nth precoding antenna port 708n may correspond to the nth transmit beam 714n formed via the nth TRP 710n. The UE 704 may receive signals from the network entity 702 via a receive beam 714.

In beam-based operation (e.g., millimeter wave bands), the actual spatial domain basis vectors may not be based on specific DFT structures. Depending on the network entity and/or UE implementation, different beam patterns may be used, and these beam patterns may be transparent to the other node. For example, the actual beam weights may not be from a specific DFT dictionary and may not be known to the other node. In this context, Type-II port selection-based codebooks may be used for precoding feedback, where the beam matrix W₁ may have binary entries (e.g., “1” indicating the corresponding port is selected, “0” otherwise).

While FIG. 7 is described in the context of multi-TRP communication, the principles of FIG. 7 can be applied in other contexts, such as multi-antenna-panel communication or MIMO communication.

### Aspects Related to an Uplink MIMO Using High Resolution Precoding Based on Channel State Information Feedback from User Equipment

In certain wireless communications systems, such as 5G NR systems and/or future wireless communications technologies, an UL MIMO procedure may be performed in a couple of ways. For example, the UL MIMO procedure may be performed based on a codebook. In the case of codebook-based UL MIMO, a wideband precoding may be supported, and the size of a DCI for an UL grant based on the wideband precoding may be relatively small (e.g., when compared to supporting a higher resolution precoding that also supports subband precoding) such as to guarantee PDCCH coverage. For example, the size of a TPMI for such UL grant may be less than 10 bits (e.g., less than or equal to 3 bits for a codebook for 2TX, and less than or equal to 6 bits for a codebook for 4TX). The size of the TPMI may increase proportionally to a number of subbands to support a higher resolution precoding.

As another example, the UL MIMO procedure may be performed as a non-codebook-based procedure. In case of non-codebook-based UL MIMO, a higher resolution precoding may be supported (e.g., when compared to the case of codebook-based UL MIMO procedure). Such higher resolution precoding (e.g., supporting subband precoding) may be supported based on a UL and DL reciprocity and transparently precoded SRS. Such non-codebook-based UL MIMO procedure may include a CSI-RS being transmitted from a network entity, a precoded SRS based on the CSI-RS being transmitted from a UE, and a UL grant being transmitted from the network entity. Thus, the UL MIMO procedure may have a latency attributable to a CSI-RS period, an SRS period, a scheduling latency from the network, and a PUSCH processing time. As an example, such latency may be as high as hundreds of ms.

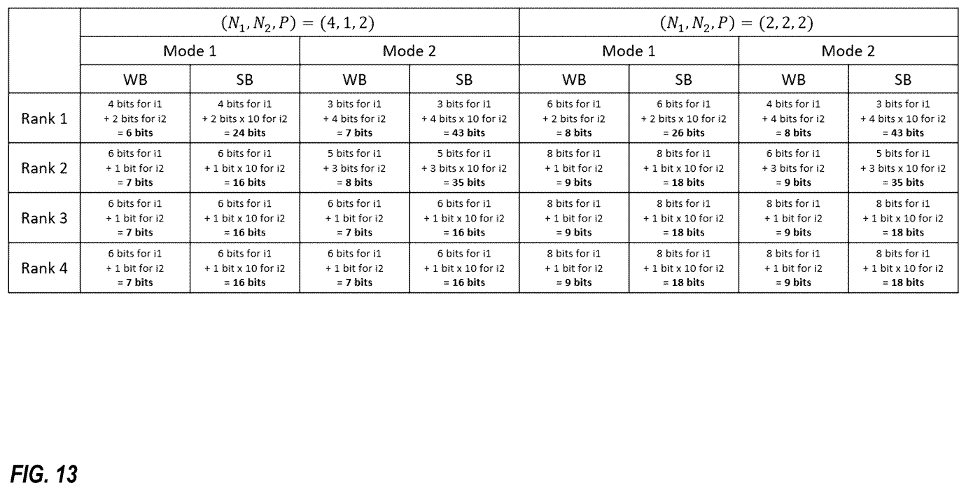

A table of PMI payload size for DL Type-I single-panel codebook, depicted in FIG. 13, corresponds to a high resolution (subband) precoding, where a maximum number of subbands for CSI reporting is 10. The table shows that more than ten bits may be used for TPMI to support the high resolution (subband) precoding.

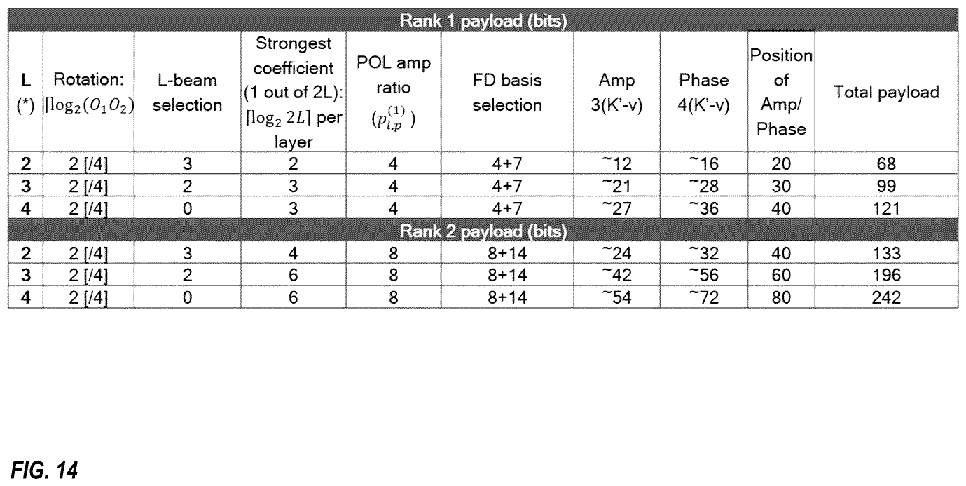

Another table of PMI payload size for DL Type-II codebook, depicted in FIG. 14, corresponds to a high resolution (subband) precoding, where (N_1, N_2, P)=(4, 1, 2)/(2, 2, 2); a maximum number of subbands for CSI reporting is 18; K=4, 4, 6 for L=2, 3, 4; and [R=2, pv=¼→Mv=5], [beta=¼→K0=5, 8, 10].

Certain aspects of the present disclosure provide an improved UL MIMO procedure that (1) uses a high resolution (subband) precoding based on a CSI feedback from a UE, and (2) is associated with a reduced CSI acquisition delay (e.g., when compared to the non-codebook-based UL MIMO procedure described above). Furthermore, the UE reports the high resolution precoding, such that the network entity can determine whether and how to use the high resolution precoding or another precoding.

FIG. 8 depicts a process flow 800 for communications in a network between a network entity 802 and a UE 804. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. In certain aspects, the network entity 802 may be an example of the network entity 502 depicted and described with respect to FIG. 5 or the network entity 702 depicted and described with respect to FIG. 7. Similarly, the UE 804 may be an example of UE 104 depicted and described with respect to FIG. 1, the UE 304 depicted and described with respect to FIG. 3, the UE 504 depicted and described with respect to FIG. 5, or the UE 704 depicted and described with respect to FIG. 7. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

At 806, the UE 804 obtains, from the network entity 802, a CSI-RS.

At 808, the UE 804 transmits, to the network entity 802, UL precoding information that identifies a precoder that is based on the CSI-RS. For example, the UL precoding information may be included in a report transmitted by the UE 804. It is understood that while the UL precoding information may be transmitted in a variety of ways, the remainder of this description will discuss an example in which the UL precoding information is transmitted in a report including (e.g., with) the UL precoding information.

In certain aspects, the uplink precoding information included in the report from the UE 804 may include wideband information and/or subband information. The uplink precoding information may indicate or support a high resolution precoding including a subband precoding. In some aspects, the UE 804 may transmit the report including the uplink precoding information via a PUCCH or a second PUSCH (e.g., a different PUSCH than the first PUSCH described as being transmitted by the UE 804 at 812, below). For example, the PUCCH or the second PUSCH may include uplink control information or other information comprising the uplink precoding information being reported by the UE 804.

In certain aspects, the report including the UL precoding information may be transmitted in a periodic, semi-persistent, or aperiodic manner, similar to a DL CSI. For example, the report may be transmitted on a configured periodic resource. As another example, the report may be transmitted on a semi-persistently configured resource that is activated for communication via dynamic signaling. As another example, the report may be transmitted on a dynamically scheduled aperiodic resource.

In certain aspects, the UE 804 may obtain, from the network entity 802, a configuration relating to transmitting the report including the uplink precoding information. The configuration may be based on (e.g., subject to) a UE capability report. For example, the configuration may include a set of parameters that are in accordance with capabilities of the UE 804 indicated by the UE capability report. In some aspects, the configuration may include an indication of a channel measurement resource. For example, the indication of the channel measurement resource may include the CSI-RS associated (e.g., QCLed) with an SRS (e.g., a specific SRS), such as the SRS described herein with respect to the operation of 814 of the process flow 800. When a first signal is QCLed with a second signal, the first signal and the second signal share one or more beam properties, such as a Doppler spread, an average delay, a Doppler shift, a spatial parameter, or the like. In certain cases, the channel measurement resource may include a number of CSI-RS ports that corresponds to a number of reception antenna ports (e.g., for UL) and/or a time or frequency resource. For example, the time or frequency resource may be indicated according to a period, an offset, a resource element location, etc.

In some aspects, the configuration may indicate a number of transmission antenna ports (e.g., a number of UL transmission antenna ports). For example, the number of transmission antenna ports may include a number of ports for an SRS associated (e.g., QCLed) with the CSI-RS. In some cases, the number of ports for the SRS may be less than or equal to a maximum number of SRS ports indicated in the UE capability report. In certain aspects, the number of transmission antenna ports may include or be defined according to a pairing of a first number and a second number, denoted (N1, N2). The pairing may be associated with a uniform rectangular array, where the first number (N1) indicates a number of rows of the uniform rectangular array, and the second number (N2) indicates a number of columns of the uniform rectangular array. The first number and the second number may be related to the number of transmission antenna ports. For example, the number of transmission antenna ports may equal N1×N2×P, where P is a number of polarizations of each antenna element.

In certain aspects, the configuration may indicate a number of layers (e.g., a number of MIMO layers). In some cases, the number of layers may be a maximum number of layers for a communication. Moreover, the configuration may include an indication of a codebook type, for example, if there are multiple codebook types (e.g., Type-I, Type-II, eType-II, low resolution, high resolution, etc.). Furthermore, the configuration may include an indication of a frequency granularity, such as regarding wideband precoding or subband precoding. For example, the configuration may indicate a wideband frequency granularity (e.g., indicating that CSI or precoding indications are provided at the granularity of a wideband) or a subband frequency granularity (e.g., indicating that CSI or precoding indications are provided at the granularity of a subband). In some aspects, the configuration may include a timing for transmitting the report and/or an indication of a resource for transmitting the report. For example, the indication of resource may include a PUCCH resource configuration or a PUSCH resource configuration for transmitting the report and the uplink precoding information via a PUCCH or a PUSCH (e.g., a second PUSCH as described above).

In certain aspects, transmitting the uplink precoding information (e.g., the report including the uplink precoding information) may be based on obtaining the configuration. For example, the report including the uplink precoding information may be transmitted in accordance with the configuration described above.

In certain aspects, the uplink precoding information may include precoding matrix information (e.g., indicating a high resolution precoding or precoder). For example, the precoding matrix information may include a precoding matrix indicator (PMI) mapped to a defined precoder of an uplink codebook (e.g., a high resolution codebook). For this example, the uplink codebook may include (e.g., re-use) a subset of a downlink codebook (e.g., Type-I, Type-II, eType-II, etc.) as a high resolution codebook for uplink communication. In some cases, the uplink codebook may include a codebook (e.g., a newly defined uplink codebook) relating to one or more UE antenna architectures. For example, a first codebook may be defined for a UE having a first number of antennas or antenna panels, a second codebook may be defined for a UE having a second number of antennas or antenna panels, and so on. As another example, the precoding matrix information may include a quantized or compressed version of an explicit precoder (e.g., an explicit uplink precoding matrix). For this example, the UE 804 may calculate the best precoding matrix (e.g., a right singular matrix) based on the CSI-RS. The UE 804 may report a quantized version of the best precoding matrix. The quantized version may be quantized according to a quantization factor (e.g., from a continuous value or a higher-granularity value to a value defined by the quantization factor, thereby reducing size of the codebook). In some aspects, the UE 804 may additionally perform FD or TD compression. For example, the UE 804 may compress the uplink precoding information (or a message carrying the uplink precoding information) in the FD, the TD, or both.

In certain aspects, the uplink precoding information may include a rank indication (e.g., if the rank indication is defined as part of the uplink precoding information or the codebook). The rank may refer to a number of columns of a precoding matrix. For example, the rank indication may include an indication of a rank (e.g., a preferred rank) determined or reported by the UE 804. Such preferred rank may be less than or equal to a maximum number of layers configured by the network entity 802. Alternatively, the rank may not be separately determined or reported by the UE 804, and the uplink precoding information may be derived based on a fixed rank which is equal to a number of layers configured by the network entity 802.

In certain aspects, a rank (e.g., the final rank) for the transmission of the first PUSCH (e.g., at 812, as described herein, below) may be based on scheduling by the network entity 802. For example, the network entity 802 may provide an indication of the rank (e.g., in accordance with the uplink precoding information). Moreover, in some cases, the uplink precoding information may include more than one set of uplink precoding information. For example, multiple sets of uplink precoding information may be reported to enable scheduling flexibility for the network entity 802.

At 810, the UE 804 obtains, from the network entity 802, an uplink grant that indicates a selected precoder. For example, in certain aspects, the uplink grant may indicate the selected precoder that the UE 804 will apply to the first PUSCH at 812, below. In certain aspects, the selected precoder is the identified precoder of the uplink precoding information. For example, an indication state of the uplink grant may indicate that the selected precoder is the identified precoder of the uplink precoding information.

In some cases, the uplink grant may include an indication related to one or more previously reported precoders. For example, the one or more previously reported precoders may be one or more of the most recently reported precoders (e.g., one or more high resolution precoding matrices). As another example, different indication states of the uplink grant may indicate different precoders, as reported via different uplink precoding information transmitted by the UE 804. It is understood that the one or more previously reported precoders may be one or more precoders previously identified in transmitted uplink precoding information.

In certain cases, the uplink grant may include rank selection information and a corresponding modulation and coding scheme (MCS) (e.g., a first MCS) corresponding to the rank selection information. Additionally, or alternatively, the uplink grant may include column selection information and a corresponding MCS (e.g., a second MCS) corresponding to the column selection information.

With respect to the rank selection information, where the rank may be denoted by “r,” the UE 804 may apply the first r columns of a previously (e.g., most recently) reported high resolution precoding matrix to a PUSCH transmission, such as for the first PUSCH described as being transmitted at 812, below. For example, the indication related to the one or more previously reported precoders may include the rank selection information and the first MCS, where the transmission of the first PUSCH may be based on a number of first columns of the one or more previously reported precoders, and the number of first columns of the one or more previously reported precoders may be based on the rank selection information.

With respect to the column selection information, the transmission of the first PUSCH described with respect to the operation of 812 may be based on one or more selected columns of the one or more previously reported precoders, where the one or more selected columns may be based on the column selection information. For example, the one or more selected columns may be used as a high resolution precoding or precoder (e.g., a high resolution precoding matrix). In some cases, the number of bits for the column selection information may be equal to

$${\sum }_{i = 1}^{R} ( \begin{matrix}R \\ i\end{matrix} ) ,$$

where R is the rank reported by the UE 804 or configured by the network entity 802. For example, R may be the total number of columns of the most recently reported high resolution precoding matrix. The UE 804 may apply the selected columns of the most recently reported high resolution precoding matrix for the first PUSCH being transmitted at 812 as described herein, below. In certain cases, if the UE 804 reports multiple (M) sets of the high resolution precoding matrix information (and rank information) within a single report, then precoding matrix selection information (e.g., jointly coded M states or separate log₂ M bits) may be additionally included in the uplink grant at 810, such that the uplink grant can differentiate which set of the precoding matrix information (e.g., of the high resolution precoding or precoder) is provided.

In certain aspects, the uplink grant may include a transmitted precoding matrix indicator (TPMI), where the TPMI may indicate one or more codepoints. In some aspects, specific codepoints of the TPMI may correspond to columns of the high resolution precoding matrix most recently reported by the UE 804. For example, the one or more codepoints may indicate a rank, and the transmission of the first PUSCH (at 812, described below) may be based on a number of first columns of the one or more previously reported precoders (e.g., the most recently reported high resolution precoding matrix), where the number of first columns may be based on (e.g., equal to) the rank. The UE 804 may apply the first r columns of the most recently reported high resolution precoding matrix to the PUSCH transmission, where r is a rank indicated by a codepoint of the uplink grant. As another example, the one or more codepoints may indicate a column selection (e.g., not necessarily first columns of the precoder), and the transmission of the first PUSCH (at 812, described below) may be based on one or more columns of the one or more previously reported precoders (e.g., the most recently reported high resolution precoding matrix), where the one or more columns may be based on the column selection. The UE 804 may apply the selected columns of the most recently reported high resolution precoding matrix to the PUSCH transmission.

In some aspects, the TPMI may indicate a codepoint of the one or more codepoints. The codepoint may correspond to a gNB-indicated wideband precoder (e.g., a wideband precoding matrix selected or indicated by the network entity 802). In certain cases, such a wideband precoding matrix may be included in a separate codebook (e.g., a low resolution codebook with wideband precoding information) or a high resolution codebook (e.g., including subband precoding information). If the TPMI in the uplink grant obtained by the UE 804 at 810 indicates a codepoint (or more than one), such as the codepoint corresponding to the gNB-indicated wideband precoder (e.g., the network entity-indicating wideband precoder), the UE 804 may apply the corresponding wideband precoding matrix to the PUSCH transmission (e.g., transmission of the first PUSCH at 812, described below). In certain cases, if the UE 804 reports multiple (M) sets of the high resolution precoding matrix information (and rank information) within a single report, then precoding matrix information (e.g., indicating one of the most recently reported M high resolution precoding matrices (e.g., high resolution precoders)) may be included in the specific codepoints for reported high resolution precoding matrices. For example, a codepoint may include or be an indication of a selected precoder.

In certain aspects, the uplink grant obtained by the UE 804 at 810 may include a high resolution precoding indicator (HR PI) and a TPMI, where the TPMI may indicate one or more codepoints. For example, the HR PI and the TPMI may be separately transmitted in the uplink grant (e.g., in different and separate fields of the same uplink grant).

If the HR PI is indicated as being “on” (e.g., based on the value of the HR PI), the TPMI may indicate one or more columns of the high resolution precoding matrix most recently reported by the UE 804. In certain cases, the HR PI may include an indication (e.g., a value) that the TPMI indicates a rank (“r”), and the transmission of the first PUSCH (e.g., at 812, described below) may be based on a number of first columns (e.g., first r columns) of the one or more previously reported precoders. The number of first columns may be based on the rank. In some cases, the HR PI include an indication (e.g., a value) that the TPMI indicates one or more columns of the one or more previously reported precoders, and the transmission of the first PUSCH (e.g., at 812, described below) may be based on the one or more columns of the one or more previously reported precoders. The one or more columns may be based on the column selection.

If the HR PI is indicated as being “off” (e.g., based on the value of the HR PI), the TPMI may indicate a wideband precoding matrix to be applied for a PUSCH. For example, the HR PI may include a value indicating that the TPMI indicates a wideband precoder to be applied for the transmission of the first PUSCH (e.g., at 812, described below). The TPMI may indicate a codepoint of the one or more codepoints described above, where the codepoint may correspond to the wideband precoder, and the transmission of the first PUSCH (e.g., at 812, described below) may be based on the wideband precoder. For example, a corresponding wideband precoding matrix may be included in a separate codebook (e.g., a separate low resolution codebook supporting wideband precoding information) or a high resolution codebook. The UE 804 may apply the corresponding wideband precoding matrix to a PUSCH transmission (e.g., the transmission of the first PUSCH at 812, described below). In certain cases, if the UE 804 reports multiple (M) sets of the high resolution precoding matrix information (and rank information) within a single report, then precoding matrix selection information (e.g., indicating one of the most recently reported M high resolution precoding matrices) may be included for the TPMI when HR PI is “on.”

At 812, the UE 804 transmits, to the network entity 802, a first PUSCH using the selected precoder.

In certain aspects, the process flow 800 may also include, at 814, the UE 804 transmitting an SRS associated with the CSI-RS. For example, the SRS is quasi co-located (QCLed) with the CSI-RS. This SRS may enable the network entity 802 to determine UL channel conditions or characteristics, such as relating to any UL interference, and the network entity 802 may, for example, schedule the transmission of an UL grant in accordance with the SRS measurements. In some cases, the selected precoder may be based on the SRS or the uplink precoding information reported by the UE 804. Transmitting the SRS at 814 and the operations of 806 (e.g., obtaining the CSI-RS) and 808 (e.g., transmitting the report including the uplink precoding information) may not necessarily be performed sequentially. For example, the operation of 814 may be performed before or after the operations of 806 and 808. In some cases, the operation of 814 does not have to wait for the completion of the operations of 806 and 808 (because the transmitted SRS is not a precoded SRS), thereby reducing a delay that would be required if the operation of 814 needed to wait for the completion of the operations of 806 and 808.

Note that the process flow illustrated in FIG. 8 is an example of performing a UL MIMO procedure using high resolution precoding based on CSI feedback from UE, and aspects of the present disclosure may be applied to performing a UL MIMO procedure using high resolution precoding based on CSI feedback from UE. Note that the process flow illustrated in FIG. 8 is described herein to facilitate an understanding of performing a UL MIMO procedure using high resolution precoding based on CSI feedback from UE, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Operations of a User Equipment

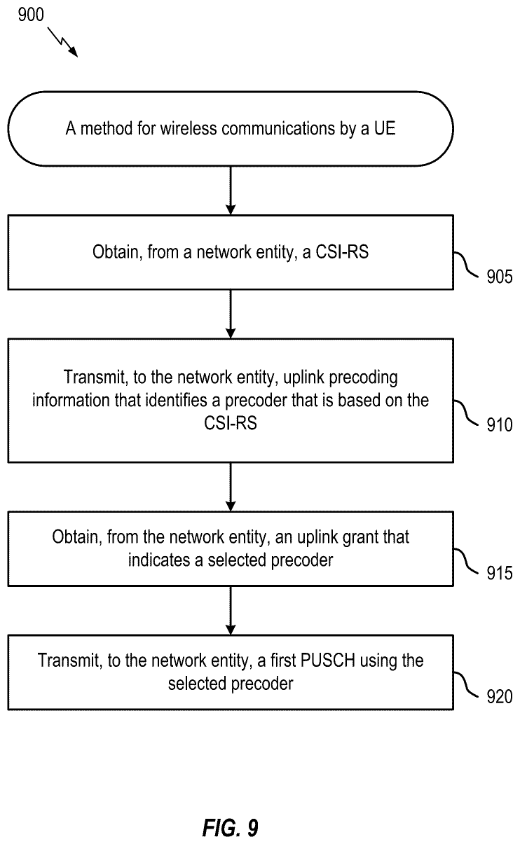

FIG. 9 shows a method 900 for wireless communications by an apparatus, such as UE 104 of FIG. 1, UE 304 of FIG. 3, UE 504 of FIG. 5, or UE 704 of FIG. 7.

Method 900 begins at block 905 with obtaining, from a network entity, a CSI-RS. For example, obtaining the CSI-RS at block 905 may correspond to the operation of 806 of FIG. 8, where the UE 804 obtains, from the network entity 802, a CSI-RS.

Method 900 then proceeds to block 910 with transmitting, to the network entity, uplink precoding information that identifies a precoder that is based on the CSI-RS. For example, transmitting the uplink precoding information at block 910 may correspond to the operation of 808 of FIG. 8, where the UE 804 transmits, to the network entity 802, UL precoding information that identifies a precoder that is based on the CSI-RS. Certain aspects of the UL precoding information of block 910 are described further herein with respect to the operation of 808 of FIG. 8. It is understood that while the UL precoding information may be transmitted in a variety of ways, the remainder of this description will discuss an example in which the UL precoding information is transmitted in a report including (e.g., with) the UL precoding information.

Method 900 then proceeds to block 915 with obtaining, from the network entity, an uplink grant that indicates a selected precoder. For example, obtaining the uplink grant at block 915 may correspond to the operation of 810 of FIG. 8, where the UE 804 obtains, from the network entity 802, an uplink grant that indicates a selected precoder. Certain aspects of the uplink grant, which indicates the selected precoder, of block 915 are described further herein with respect to the operation of 810 of FIG. 8.

Method 900 then proceeds to block 920 with transmitting, to the network entity, a first PUSCH using the selected precoder. For example, transmitting the first PUSCH using the selected precoder at block 920 may correspond to (and is described further herein with respect to) the operation of 812 of FIG. 8, where the UE 804 transmits, to the network entity 802, the first PUSCH.

In some aspects, the selected precoder is the identified precoder of the uplink precoding information.

In some aspects, method 900 further includes transmitting an SRS associated with the CSI-RS.

In some aspects, the SRS is QCLed with the CSI-RS.

In some aspects, the selected precoder is based on the SRS or the uplink precoding information reported by the UE.

In some aspects, the uplink precoding information comprises at least one of wideband information or subband information.

In some aspects, block 910 includes transmitting a PUCCH or a second PUSCH, the PUCCH or the second PUSCH comprising the uplink precoding information.

In some aspects, method 900 further includes obtaining, from the network entity, a configuration relating to transmitting the report comprising the uplink precoding information, the configuration being based on a UE capability report.

In some aspects, the configuration comprises an indication of a channel measurement resource, wherein the indication of the channel measurement resource comprises the CSI-RS associated with an SRS.

In some aspects, the channel measurement resource comprises at least one of: a number of CSI-RS ports that corresponds to a number of reception antenna ports, or a time or frequency resource.

In some aspects, the configuration comprises a number of transmission antenna ports.

In some aspects, the number of transmission antenna ports comprises a number of ports for an SRS associated with the CSI-RS.

In some aspects, the number of ports for the SRS is less than or equal to a maximum number of SRS ports indicated in the UE capability report.

In some aspects, the number of transmission antenna ports comprises a pairing of a first number and a second number, the pairing being associated with a uniform rectangular array, the first number indicating a number of rows of the uniform rectangular array, the second number indicating a number of columns of the uniform rectangular array, wherein the first number and the second number are related to the number of transmission antenna ports.

In some aspects, the configuration comprises a number of layers.

In some aspects, the number of layers comprises a maximum number of layers.

In some aspects, the configuration comprises an indication of a codebook type.

In some aspects, the configuration comprises an indication of a frequency granularity.

In some aspects, the configuration comprises a timing for transmitting the report comprising the uplink precoding information.

In some aspects, the configuration comprises an indication of resource for transmitting the report comprising the uplink precoding information, the indication of resource comprising a PUCCH resource configuration or a PUSCH resource configuration.

In some aspects, block 910 includes transmitting the uplink precoding information based on obtaining the configuration.

In some aspects, the uplink precoding information comprises precoding matrix information.

In some aspects, the precoding matrix information comprises a PMI mapped to a defined precoder within an uplink codebook.

In some aspects, the uplink codebook comprises a subset of a downlink codebook.

In some aspects, the uplink codebook comprises a codebook relating to one or more UE antenna architectures.

In some aspects, the precoding matrix information comprises a quantized or compressed version of an explicit precoder.

In some aspects, the uplink precoding information comprises a rank indication.

In some aspects, the rank indication comprises an indication of a rank determined by the UE.

In some aspects, the uplink precoding information is derived based on a fixed rank which is equal to a number of layers configured by the network entity.

In some aspects, a rank for the transmission of the first PUSCH is based on scheduling by the network entity.

In some aspects, the uplink precoding information comprises more than one set of uplink precoding information.

In some aspects, the uplink grant comprises an indication related to one or more previously reported precoders. It is understood that the one or more previously reported precoders may be one or more precoders previously identified in transmitted uplink precoding information.

In some aspects, the indication related to the one or more previously reported precoders comprises at least one of: rank selection information and a first MCS corresponding to the rank selection information, or column selection information and a second MCS corresponding to the column selection information.

In some aspects, the indication related to the one or more previously reported precoders comprises the rank selection information and the first MCS, wherein the transmission of the first PUSCH is based on a number of first columns of the one or more previously reported precoders, the number of first columns based on the rank selection information.

In some aspects, the indication related to the one or more previously reported precoders comprises the column selection information and the second MCS, wherein the transmission of the first PUSCH is based on one or more selected columns of the one or more previously reported precoders, the one or more selected columns based on the column selection information.

In some aspects, the uplink grant comprises a TPMI, the TPMI indicating one or more codepoints.

In some aspects, the one or more codepoints indicate a rank, and the transmission of the first PUSCH is based on a number of first columns of the one or more previously reported precoders, the number of first columns based on the rank.

In some aspects, the one or more codepoints indicate a column selection, and the transmission of the first PUSCH is based on one or more columns of the one or more previously reported precoders, the one or more columns based on the column selection.

In some aspects, the TPMI indicates a codepoint of the one or more codepoints, the codepoint corresponding to a network entity-indicating wideband precoder, and the transmission of the first PUSCH is based on the network entity-indicating wideband precoder.

In some aspects, the uplink grant comprises a HR PI and a TPMI, the TPMI indicating one or more codepoints.

In some aspects, the HR PI includes a value indicating that the TPMI indicates a rank, and the transmission of the first PUSCH is based on a number of first columns of the one or more previously reported precoders, the number of first columns based on the rank.

In some aspects, the HR PI includes a value indicating that the TPMI indicates one or more columns of the one or more previously reported precoders, and the transmission of the first PUSCH is based on the one or more columns of the one or more previously reported precoders, the one or more columns based on the column selection.

In some aspects, the HR PI includes a value indicating that the TPMI indicates a wideband precoder to be applied for the transmission of the first PUSCH, the TPMI indicates a codepoint of the one or more codepoints, the codepoint corresponding to the wideband precoder, and the transmission of the first PUSCH is based on the wideband precoder.

In certain aspects, the method 900 using the report including uplink precoding information that identifies a precoder that is based on the CSI-RS (e.g., of a high resolution precoding), described herein with respect to block 910, may use less UL overhead than a non-codebook-based UL MIMO procedure using a non-codebook-based SRS. For example, a non-codebook-based UL MIMO procedure that utilizes such non-codebook-based SRS has an operational latency associated with a three-way operation related to (1) a network entity transmitting a CSI-RS, (2) a UE transmitting a precoded SRS, and (3) the network entity transmitting a UL grant. The method 900 which uses, for example, the report of block 910 avoids, at least in part, the latency associated with such three-way operation of the non-codebook-based UL MIMO procedure (e.g., including a CSI-RS period, an SRS period, a network entity scheduling latency, and a PUSCH processing time). Accordingly, the method 900 may reduce an overall latency associated with a UL MIMO procedure that uses a high resolution precoding (e.g., when compared to a non-codebook-based UL MIMO procedure using a non-codebook-based SRS).

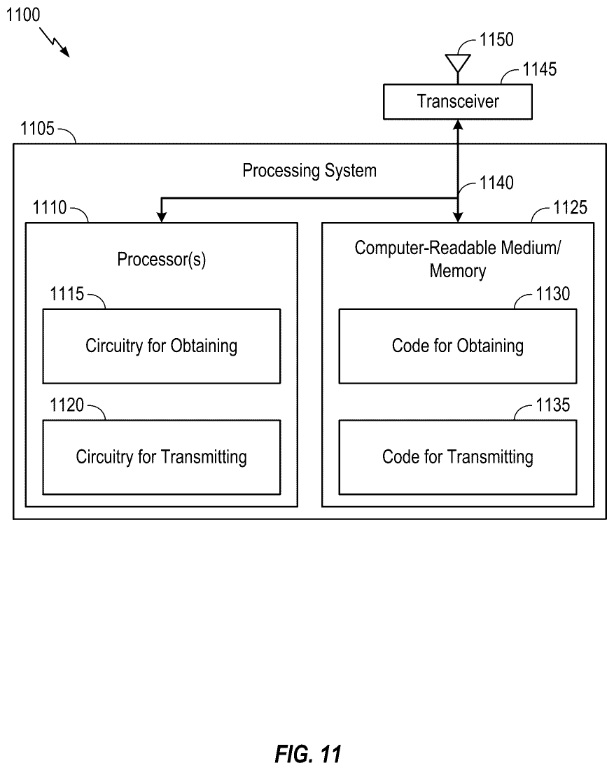

In some aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Operations of a Network Entity

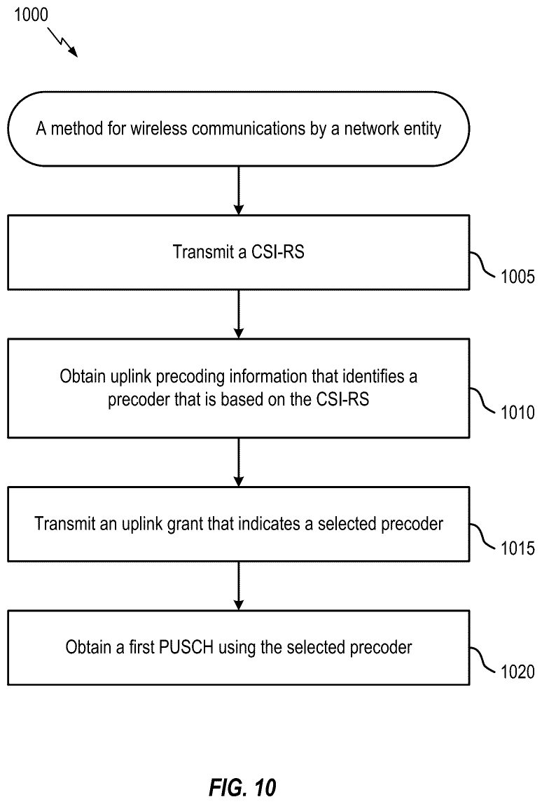

FIG. 10 shows a method 1000 for wireless communications by an apparatus, such as BS 102 of FIG. 1, a first network entity 300 or second network entity 302 of FIG. 3, a disaggregated base station as discussed with respect to FIG. 2, a network entity 502 of FIG. 5, or a network entity 702 of FIG. 7.

Method 1000 begins at block 1005 with transmitting a CSI-RS. For example, transmitting the CSI-RS at block 1005 may correspond to the operation of 806 of FIG. 8, where the network entity 802 transmits a CSI-RS.

Method 1000 then proceeds to block 1010 with obtaining uplink precoding information that identifies a precoder that is based on the CSI-RS. For example, the uplink precoding information obtained at block 1010 may correspond to the uplink precoding information described herein with respect to the operation of 808 of FIG. 8. It is understood that while the UL precoding information may be obtained in a variety of ways, the remainder of this description will discuss an example in which the UL precoding information is obtained in a report including (e.g., with) the UL precoding information.

Method 1000 then proceeds to block 1015 with transmitting an uplink grant that indicates a selected precoder. For example, the uplink grant transmitted at block 1015 may correspond to the uplink grant described herein with respect to the operation of 810 of FIG. 8.

Method 1000 then proceeds to block 1020 with obtaining a first PUSCH using the selected precoder. For example, the first PUSCH obtained at block 1020 may correspond to the first PUSCH described herein with respect to the operation of 812 of FIG. 8.

In some aspects, the selected precoder is the identified precoder of the uplink precoding information.

In certain aspects, method 1000 further includes obtaining an SRS associated with the CSI-RS.

In some aspects, the SRS is QCLed with the CSI-RS.

In some aspects, the selected precoder is based on the SRS or the uplink precoding information.

In some aspects, the uplink precoding information comprises at least one of wideband information or subband information.

In some aspects, block 1010 includes obtaining a PUCCH or a second PUSCH, the PUCCH or the second PUSCH comprising the uplink precoding information.

In certain aspects, method 1000 further includes transmitting a configuration relating to the report comprising the uplink precoding information being transmitted, the configuration being based on a UE capability report.

In some aspects, the configuration comprises an indication of a channel measurement resource, wherein the indication of the channel measurement resource comprises the CSI-RS associated with an SRS.

In some aspects, the channel measurement resource comprises at least one of: a number of CSI-RS ports that corresponds to a number of reception antenna ports, or a time or frequency resource.

In some aspects, the configuration comprises a number of transmission antenna ports.

In some aspects, the number of transmission antenna ports comprises a number of ports for an SRS associated with the CSI-RS.

In some aspects, the number of ports for the SRS is less than or equal to a maximum number of SRS ports indicated in the UE capability report.

In some aspects, the number of transmission antenna ports comprises a pairing of a first number and a second number, the pairing being associated with a uniform rectangular array, the first number indicating a number of rows of the uniform rectangular array, the second number indicating a number of columns of the uniform rectangular array, wherein the first number and the second number are related to the number of transmission antenna ports.

In some aspects, the configuration comprises a number of layers.

In some aspects, the number of layers comprises a maximum number of layers.

In some aspects, the configuration comprises an indication of a codebook type.

In some aspects, the configuration comprises an indication of a frequency granularity.

In some aspects, the configuration comprises a timing for the report comprising the uplink precoding information to be transmitted.

In some aspects, the configuration comprises an indication of resource for the report comprising the uplink precoding information to be transmitted on, the indication of resource comprising a PUCCH resource configuration or a PUSCH resource configuration.

In some aspects, block 1010 includes obtaining the uplink precoding information based on the configuration.

In some aspects, the uplink precoding information comprises precoding matrix information.

In some aspects, the precoding matrix information comprises a PMI mapped to a defined precoder within an uplink codebook.

In some aspects, the uplink codebook comprises a subset of a downlink codebook.

In some aspects, the uplink codebook comprises a codebook relating to one or more UE antenna architectures.

In some aspects, the precoding matrix information comprises a quantized or compressed version of an explicit precoder.

In some aspects, the uplink precoding information comprises a rank indication.

In some aspects, the rank indication comprises an indication of a rank determined by a UE.

In some aspects, the uplink precoding information is derived based on a fixed rank which is equal to a number of layers configured by the network entity for a UE.

In some aspects, a rank for transmission, by a UE, of the first PUSCH is based on scheduling by the network entity.

In some aspects, the uplink precoding information comprises more than one set of uplink precoding information.

In some aspects, the uplink grant comprises an indication related to one or more previously reported precoders. It is understood that the one or more previously reported precoders may be one or more precoders previously identified in obtained uplink precoding information.

In some aspects, the indication related to the one or more previously reported precoders comprises at least one of: rank selection information and a first MCS corresponding to the rank selection information, or column selection information and a second MCS corresponding to the column selection information.

In some aspects, the indication related to the one or more previously reported precoders comprises the rank selection information and the first MCS, wherein a number of first columns of the one or more previously reported precoders is related to the first PUSCH being transmitted, the number of first columns based on the rank selection information.

In some aspects, the indication related to the one or more previously reported precoders comprises the column selection information and the second MCS, wherein one or more selected columns of the one or more previously reported precoders are related to the first PUSCH being transmitted, the one or more selected columns based on the column selection information.

In some aspects, the uplink grant comprises an TPMI, the TPMI indicating one or more codepoints.

In some aspects, the one or more codepoints indicate a rank, and a number of first columns of the one or more previously reported precoders is related to the first PUSCH being transmitted, the number of first columns based on the rank.

In some aspects, the one or more codepoints indicate a column selection, and one or more columns of the one or more previously reported precoders are related to the first PUSCH being transmitted, the one or more columns based on the column selection.

In some aspects, the TPMI indicates a codepoint of the one or more codepoints, the codepoint corresponding to a network entity-indicating wideband precoder, and the network entity-indicating wideband precoder is related to the first PUSCH being transmitted.

In some aspects, the uplink grant comprises a HR PI and an TPMI, the TPMI indicating one or more codepoints.

In some aspects, the HR PI includes a value indicating that the TPMI indicates a rank, and a number of first columns of the one or more previously reported precoders is related to the first PUSCH being transmitted, the number of first columns based on the rank.

In some aspects, the HR PI includes a value indicating that the TPMI indicates one or more columns of the one or more previously reported precoders, and the one or more columns of the one or more previously reported precoders are related to the first PUSCH being transmitted, the one or more columns based on the column selection.

In some aspects, the HR PI includes a value indicating that the TPMI indicates a wideband precoder to be applied for transmission, by a UE, of the first PUSCH, the TPMI indicates a codepoint of the one or more codepoints, the codepoint corresponding to the wideband precoder, and the wideband precoder is related to the first PUSCH being transmitted.

In certain aspects, the method 1000 enables a UE to perform a UL MIMO procedure using a high resolution precoding with a reduced delay (e.g., when compared to a non-codebook-based UL MIMO procedure using a non-codebook-based SRS). Furthermore, by providing a UL grant that provides a selected precoder based on uplink precoding information that identifies a precoder (e.g. a high resolution precoding matrix) that is based on a CSI-RS, the network entity performing the method 1000 may enable a UL MIMO procedure that is more reliable (e.g., since a report based on a CSI-RS may be more reliable than a report based on a non-codebook-based SRS).

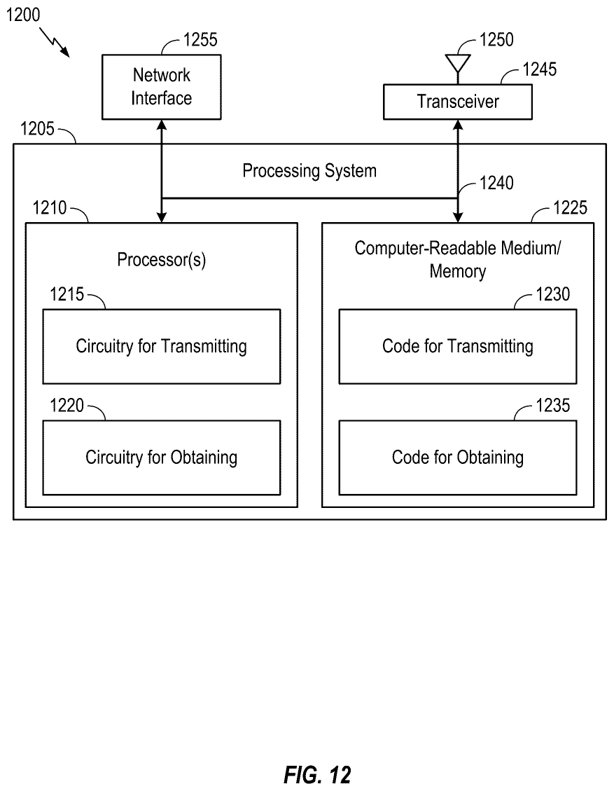

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100 configured for wireless communications. In some aspects, communications device 1100 is a user equipment, such as UE 104 described above with respect to FIG. 1, UE 304 described with respect to FIG. 3, UE 504 described with respect to FIG. 5, or UE 704 described with respect to FIG. 7.

The communications device 1100 includes a processing system 1105 coupled to a transceiver 1145 (e.g., a transmitter and/or a receiver). The transceiver 1145 is configured to transmit and receive signals for the communications device 1100 via an antenna 1150, such as the various signals as described herein. The processing system 1105 may be configured to perform processing functions for the communications device 1100, including processing signals received and/or to be transmitted by the communications device 1100.

The processing system 1105 includes one or more processors 1110 and a computer-readable medium/memory 1125. In various aspects, the one or more processors 1110 may be representative of the one or more processors 318 described with respect to FIG. 3. The one or more processors 1110 are coupled to a computer-readable medium/memory 1125 via a bus 1140. In some aspects, the computer-readable medium/memory 1125 may be representative of the one or more memories 320 described with respect to FIG. 3. The computer-readable medium/memory 1125 is a non-transitory computer-readable medium/memory. In certain aspects, the computer-readable medium/memory 1125 is configured to store instructions (e.g., computer-executable code), that when executed by the one or more processors 1110, cause the one or more processors 1110 to perform the method 900 described with respect to FIG. 9, or any aspect related to it, including any operations described in relation to FIG. 9. Note that reference to a processor performing a function of communications device 1100 may include one or more processors performing that function of communications device 1100, such as in a distributed fashion.

In the depicted example, computer-readable medium/memory 1125 stores code (e.g., executable instructions), including code for obtaining 1130 and code for transmitting 1135. Processing of the code 1130 and 1135 may enable and cause the communications device 1100 to perform the method 900 described with respect to FIG. 9, or any aspect related to it. For instance, in some aspects, code for obtaining 1130 includes code for obtaining, from a network entity, a CSI-RS, such as performed at block 905 of FIG. 9. In some aspects, code for transmitting 1135 includes code for transmitting, to the network entity, uplink precoding information that identifies a precoder that is based on the CSI-RS, such as performed at block 910 of FIG. 9. In some aspects, code for obtaining 1130 includes code for obtaining, from the network entity, an uplink grant that indicates a selected precoder, such as performed at block 915 of FIG. 9. In some aspects, code for transmitting 1135 includes code for transmitting, to the network entity, a first PUSCH using the selected precoder, such as performed at block 920 of FIG. 9.

The one or more processors 1110 include circuitry configured to implement (e.g., execute) the code stored in the computer-readable medium/memory 1125, including circuitry for obtaining 1115 and circuitry for transmitting 1120. Processing with circuitry 1115 and 1120 may enable and cause the communications device 1100 to perform the method 900 described with respect to FIG. 9, or any aspect related to it. For instance, in some aspects, circuitry for obtaining 1115 includes circuitry for obtaining, from a network entity, a CSI-RS, such as performed at block 905 of FIG. 9. In some aspects, circuitry for transmitting 1120 includes circuitry for transmitting, to the network entity, uplink precoding information that identifies a precoder that is based on the CSI-RS, such as performed at block 910 of FIG. 9. In some aspects, circuitry for obtaining 1115 includes circuitry for obtaining, from the network entity, an uplink grant that indicates a selected precoder, such as performed at block 915 of FIG. 9. In some aspects, circuitry for transmitting 1120 includes circuitry for transmitting, to the network entity, a first PUSCH using the selected precoder, such as performed at block 920 of FIG. 9.

More generally, means for communicating, transmitting, sending or outputting for transmission may include the one or more transceivers 324, one or more antenna 322 and/or processing system 316 of the UE 304 illustrated in FIG. 3, transceiver 1145 and/or antenna 1150 of the communications device 1100 in FIG. 11, and/or one or more processors 1110 of the communications device 1100 in FIG. 11. Means for communicating, receiving or obtaining may include the one or more transceivers 324, one or more antennas 322, and/or processing system 316 of the UE 304 illustrated in FIG. 3, transceiver 1145 and/or antenna 1150 of the communications device 1100 in FIG. 11, and/or one or more processors 1110 of the communications device 1100 in FIG. 11.

FIG. 12 depicts aspects of an example communications device configured for wireless communications. In some aspects, communications device 1200 is a network entity, such as BS 102 of FIG. 1, first network entity 300 or second network entity 302 of FIG. 3, a disaggregated base station as discussed with respect to FIG. 2, network entity 502 of FIG. 5, or network entity 702 of FIG. 7.

The communications device 1200 includes a processing system 1205 coupled to a transceiver 1245 (e.g., a transmitter and/or a receiver) and/or a network interface 1255. The transceiver 1245 is configured to transmit and receive signals for the communications device 1200 via an antenna 1250, such as the various signals as described herein. The network interface 1255 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210 and a computer-readable medium/memory 1225. In various aspects, one or more processors 1210 may be representative of the one or more processors 308, as described with respect to FIG. 3. The one or more processors 1210 are coupled to the computer-readable medium/memory 1225 via a bus 1240. In certain aspects, the computer-readable medium/memory 1225 is configured to store instructions (e.g., computer-executable code), including code 1230 and 1235, that when executed by the one or more processors 1210, cause the one or more processors 1210 to perform the method 1000 described with respect to FIG. 10, or any aspect related to it, including any operations described in relation to FIG. 10. The computer-readable medium/memory 1225 is a non-transitory computer-readable medium/memory. Note that reference to a processor of communications device 1200 performing a function may include one or more processors of communications device 1200 performing that function, such as in a distributed fashion.

In the depicted example, the computer-readable medium/memory 1225 stores code (e.g., executable instructions), including code for transmitting 1230 and code for obtaining 1235. Processing of the code 1230 and 1235 may enable and cause the communications device 1200 to perform the method 1000 described with respect to FIG. 10, or any aspect related to it. For instance, in some aspects, code for transmitting 1230 includes code for transmitting a CSI-RS, such as performed at block 1005 of FIG. 10. In some aspects, code for obtaining 1235 includes code for obtaining uplink precoding information that identifies a precoder that is based on the CSI-RS, such as performed at block 1010 of FIG. 10. In some aspects, code for transmitting 1230 includes code for transmitting an uplink grant that indicates a selected precoder, such as performed at block 1015 of FIG. 10. In some aspects, code for obtaining 1235 includes code for obtaining a first PUSCH using the selected precoder, such as performed at block 1020 of FIG. 10.

The one or more processors 1210 include circuitry configured to implement (e.g., execute) the code stored in the computer-readable medium/memory 1225, including circuitry for transmitting 1215 and circuitry for obtaining 1220. Processing with circuitry 1215 and 1220 may enable and cause the communications device 1200 to perform the method 1000 described with respect to FIG. 10, or any aspect related to it. For instance, in some aspects, circuitry for transmitting 1215 includes circuitry for transmitting a CSI-RS, such as performed at block 1005 of FIG. 10. In some aspects, circuitry for obtaining 1220 includes circuitry for obtaining uplink precoding information that identifies a precoder that is based on the CSI-RS, such as performed at block 1010 of FIG. 10. In some aspects, circuitry for transmitting 1215 includes circuitry for transmitting an uplink grant that indicates a selected precoder, such as performed at block 1015 of FIG. 10. In some aspects, circuitry for obtaining 1220 includes circuitry for obtaining a first PUSCH using the selected precoder, such as performed at block 1020 of FIG. 10.

Various components of the communications device 1200 may provide means for performing the method 1000 described with respect to FIG. 10, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1245, antenna 1250, and/or network interface 1255 of the communications device 1200 in FIG. 12, and/or one or more processors 1210 of the communications device 1200 in FIG. 12. Means for communicating, receiving or obtaining may include the one or more transceivers 312, one or more antennas 314, and/or processing system 306 of the first network entity 300 or the second network entity 302 illustrated in FIG. 3, transceiver 1245, antenna 1250, and/or network interface 1255 of the communications device 1200 in FIG. 12, and/or one or more processors 1210 of the communications device 1200 in FIG. 12.

### EXAMPLE CLAUSES

Implementation examples are described in the following numbered clauses:

Clause 1: A method for wireless communications, comprising: obtaining, from a network entity, a CSI-RS; transmitting, to the network entity, uplink precoding information that identifies a precoder that is based on the CSI-RS; obtaining, from the network entity, an uplink grant that indicates a selected precoder; and transmitting, to the network entity, a first PUSCH using the selected precoder.

Clause 2: The method of Clause 1, wherein the selected precoder is the identified precoder of the uplink precoding information.

Clause 3: The method of any one of Clauses 1-2, further comprising transmitting an SRS associated with the CSI-RS.

Clause 4: The method of Clause 3, wherein the SRS is QCLed with the CSI-RS.

Clause 5: The method of Clause 3, wherein the selected precoder is based on the SRS or the uplink precoding information transmitted by a UE.

Clause 6: The method of any one of Clauses 1-5, wherein the uplink precoding information comprises at least one of wideband information or subband information.

Clause 7: The method of any one of Clauses 1-6, wherein transmitting the uplink precoding information comprises transmitting a PUCCH or a second PUSCH, the PUCCH or the second PUSCH comprising the uplink precoding information.

Clause 8: The method of any one of Clauses 1-7, further comprising obtaining, from the network entity, a configuration relating to transmitting the uplink precoding information, the configuration being based on a UE capability report.

Clause 9: The method of Clause 8, wherein the configuration comprises an indication of a channel measurement resource, wherein the indication of the channel measurement resource comprises the CSI-RS associated with an SRS.

Clause 10: The method of Clause 9, wherein the channel measurement resource comprises at least one of: a number of CSI-RS ports that corresponds to a number of reception antenna ports, or a time or frequency resource.

Clause 11: The method of Clause 8, wherein the configuration comprises a number of transmission antenna ports.

Clause 12: The method of Clause 11, wherein the number of transmission antenna ports comprises a number of ports for an SRS associated with the CSI-RS.

Clause 13: The method of Clause 12, wherein the number of ports for the SRS is less than or equal to a maximum number of SRS ports indicated in the UE capability report.

Clause 14: The method of Clause 11, wherein the number of transmission antenna ports comprises a pairing of a first number and a second number, the pairing being associated with a uniform rectangular array, the first number indicating a number of rows of the uniform rectangular array, the second number indicating a number of columns of the uniform rectangular array, wherein the first number and the second number are related to the number of transmission antenna ports.

Clause 15: The method of Clause 8, wherein the configuration comprises a number of layers.

Clause 16: The method of Clause 15, wherein the number of layers comprises a maximum number of layers.

Clause 17: The method of Clause 8, wherein the configuration comprises an indication of a codebook type.

Clause 18: The method of Clause 8, wherein the configuration comprises an indication of a frequency granularity.

Clause 19: The method of Clause 8, wherein the configuration comprises a timing for transmitting the uplink precoding information.

Clause 20: The method of Clause 8, wherein the configuration comprises an indication of resource for transmitting the uplink precoding information, the indication of resource comprising a PUCCH resource configuration or a PUSCH resource configuration.

Clause 21: The method of Clause 8, wherein transmitting the uplink precoding information comprises transmitting the uplink precoding information based on obtaining the configuration.

Clause 22: The method of any one of Clauses 1-21, wherein the uplink precoding information comprises precoding matrix information.

Clause 23: The method of Clause 22, wherein the precoding matrix information comprises a PMI mapped to a defined precoder within an uplink codebook.

Clause 24: The method of Clause 23, wherein the uplink codebook comprises a subset of a downlink codebook.

Clause 25: The method of Clause 23, wherein the uplink codebook comprises a codebook relating to one or more UE antenna architectures.

Clause 26: The method of Clause 22, wherein the precoding matrix information comprises a quantized or compressed version of an explicit precoder.

Clause 27: The method of any one of Clauses 1-26, wherein the uplink precoding information comprises a rank indication.

Clause 28: The method of Clause 27, wherein the rank indication comprises an indication of a rank determined by a UE.

Clause 29: The method of Clause 27, wherein the uplink precoding information is derived based on a fixed rank which is equal to a number of layers configured by the network entity.

Clause 30: The method of any one of Clauses 1-29, wherein a rank for the transmission of the first PUSCH is based on scheduling by the network entity.

Clause 31: The method of any one of Clauses 1-30, wherein the uplink precoding information comprises more than one set of uplink precoding information.

Clause 32: The method of any one of Clauses 1-31, wherein the uplink grant comprises an indication related to one or more precoders previously identified in transmitted uplink precoding information.

Clause 33: The method of Clause 32, wherein the indication related to the one or more precoders previously identified in transmitted uplink precoding information comprises at least one of: rank selection information and a first MCS corresponding to the rank selection information, or column selection information and a second MCS corresponding to the column selection information.

Clause 34: The method of Clause 33, wherein the indication related to the one or more precoders previously identified in transmitted uplink precoding information comprises the rank selection information and the first MCS, wherein the transmission of the first PUSCH is based on a number of first columns of the one or more precoders previously identified in transmitted uplink precoding information, the number of first columns based on the rank selection information.

Clause 35: The method of Clause 33, wherein the indication related to the one or more precoders previously identified in transmitted uplink precoding information comprises the column selection information and the second MCS, wherein the transmission of the first PUSCH is based on one or more selected columns of the one or more precoders previously identified in transmitted uplink precoding information, the one or more selected columns based on the column selection information.

Clause 36: The method of Clause 32, wherein the uplink grant comprises a TPMI, the TPMI indicating one or more codepoints.

Clause 37: The method of Clause 36, wherein the one or more codepoints indicate a rank, and the transmission of the first PUSCH is based on a number of first columns of the one or more precoders previously identified in transmitted uplink precoding information, the number of first columns based on the rank.

Clause 38: The method of Clause 36, wherein the one or more codepoints indicate a column selection, and the transmission of the first PUSCH is based on one or more columns of the one or more precoders previously identified in transmitted uplink precoding information, the one or more columns based on the column selection.

Clause 39: The method of Clause 36, wherein the TPMI indicates a codepoint of the one or more codepoints, the codepoint corresponding to a network entity-indicating wideband precoder, and the transmission of the first PUSCH is based on the network entity-indicating wideband precoder.

Clause 40: The method of Clause 32, wherein the uplink grant comprises a HR PI and a TPMI, the TPMI indicating one or more codepoints.

Clause 41: The method of Clause 40, wherein: the HR PI includes a value indicating that the TPMI indicates a rank, and the transmission of the first PUSCH is based on a number of first columns of the one or more precoders previously identified in transmitted uplink precoding information, the number of first columns based on the rank.

Clause 42: The method of Clause 40, wherein: the HR PI includes a value indicating that the TPMI indicates one or more columns of the one or more precoders previously identified in transmitted uplink precoding information, and the transmission of the first PUSCH is based on the one or more columns of the one or more precoders previously identified in transmitted uplink precoding information, the one or more columns based on the column selection.

Clause 43: The method of Clause 40, wherein: the HR PI includes a value indicating that the TPMI indicates a wideband precoder to be applied for the transmission of the first PUSCH, the TPMI indicates a codepoint of the one or more codepoints, the codepoint corresponding to the wideband precoder, and the transmission of the first PUSCH is based on the wideband precoder.

Clause 44: A method for wireless communications, comprising: transmitting a CSI-RS; obtaining uplink precoding information that identifies a precoder that is based on the CSI-RS; transmitting an uplink grant that indicates a selected precoder; and obtaining a first PUSCH using the selected precoder.

Clause 45: The method of Clause 44, wherein the selected precoder is the identified precoder of the uplink precoding information.

Clause 46: The method of any one of Clauses 44-45, further comprising obtaining an SRS associated with the CSI-RS.

Clause 47: The method of Clause 46, wherein the SRS is QCLed with the CSI-RS.

Clause 48: The method of Clause 46, wherein the selected precoder is based on the SRS or the uplink precoding information.

Clause 49: The method of any one of Clauses 44-48, wherein the uplink precoding information comprises at least one of wideband information or subband information.

Clause 50: The method of any one of Clauses 44-49, wherein obtaining the uplink precoding information comprises obtaining a PUCCH or a second PUSCH, the PUCCH or the second PUSCH comprising the uplink precoding information.

Clause 51: The method of any one of Clauses 44-50, further comprising transmitting a configuration relating to the uplink precoding information being transmitted, the configuration being based on a UE capability report.

Clause 52: The method of Clause 51, wherein the configuration comprises an indication of a channel measurement resource, wherein the indication of the channel measurement resource comprises the CSI-RS associated with an SRS.

Clause 53: The method of Clause 52, wherein the channel measurement resource comprises at least one of: a number of CSI-RS ports that corresponds to a number of reception antenna ports, or a time or frequency resource.

Clause 54: The method of Clause 51, wherein the configuration comprises a number of transmission antenna ports.

Clause 55: The method of Clause 54, wherein the number of transmission antenna ports comprises a number of ports for an SRS associated with the CSI-RS.

Clause 56: The method of Clause 55, wherein the number of ports for the SRS is less than or equal to a maximum number of SRS ports indicated in the UE capability report.

Clause 57: The method of Clause 54, wherein the number of transmission antenna ports comprises a pairing of a first number and a second number, the pairing being associated with a uniform rectangular array, the first number indicating a number of rows of the uniform rectangular array, the second number indicating a number of columns of the uniform rectangular array, wherein the first number and the second number are related to the number of transmission antenna ports.

Clause 58: The method of Clause 51, wherein the configuration comprises a number of layers.

Clause 59: The method of Clause 58, wherein the number of layers comprises a maximum number of layers.

Clause 60: The method of Clause 51, wherein the configuration comprises an indication of a codebook type.

Clause 61: The method of Clause 51, wherein the configuration comprises an indication of a frequency granularity.

Clause 62: The method of Clause 51, wherein the configuration comprises a timing for the uplink precoding information to be transmitted.

Clause 63: The method of Clause 51, wherein the configuration comprises an indication of resource for the uplink precoding information to be transmitted on, the indication of resource comprising a PUCCH resource configuration or a PUSCH resource configuration.

Clause 64: The method of Clause 51, wherein obtaining the uplink precoding information comprises obtaining the uplink precoding information based on the configuration.

Clause 65: The method of any one of Clauses 44-64, wherein the uplink precoding information comprises precoding matrix information.

Clause 66: The method of Clause 65, wherein the precoding matrix information comprises a PMI mapped to a defined precoder within an uplink codebook.

Clause 67: The method of Clause 66, wherein the uplink codebook comprises a subset of a downlink codebook.

Clause 68: The method of Clause 66, wherein the uplink codebook comprises a codebook relating to one or more UE antenna architectures.

Clause 69: The method of Clause 65, wherein the precoding matrix information comprises a quantized or compressed version of an explicit precoder.

Clause 70: The method of any one of Clauses 44-69, wherein the uplink precoding information comprises a rank indication.

Clause 71: The method of Clause 70, wherein the rank indication comprises an indication of a rank determined by a UE.

Clause 72: The method of Clause 70, wherein the uplink precoding information is derived based on a fixed rank which is equal to a number of layers configured by the network entity for a UE.

Clause 73: The method of any one of Clauses 44-72, wherein a rank for transmission, by a UE, of the first PUSCH is based on scheduling by the network entity.

Clause 74: The method of any one of Clauses 44-73, wherein the uplink precoding information comprises more than one set of uplink precoding information.

Clause 75: The method of any one of Clauses 44-74, wherein the uplink grant comprises an indication related to one or more precoders previously identified in obtained uplink precoding information.

Clause 76: The method of Clause 75, wherein the indication related to the one or more precoders previously identified in obtained uplink precoding information comprises at least one of: rank selection information and a first MCS corresponding to the rank selection information, or column selection information and a second MCS corresponding to the column selection information.

Clause 77: The method of Clause 76, wherein the indication related to the one or more precoders previously identified in obtained uplink precoding information comprises the rank selection information and the first MCS, wherein a number of first columns of the one or more precoders previously identified in obtained uplink precoding information is related to the first PUSCH being transmitted, the number of first columns based on the rank selection information.

Clause 78: The method of Clause 76, wherein the indication related to the one or more precoders previously identified in obtained uplink precoding information comprises the column selection information and the second MCS, wherein one or more selected columns of the one or more precoders previously identified in obtained uplink precoding information are related to the first PUSCH being transmitted, the one or more selected columns based on the column selection information.

Clause 79: The method of Clause 75, wherein the uplink grant comprises an TPMI, the TPMI indicating one or more codepoints.

Clause 80: The method of Clause 79, wherein the one or more codepoints indicate a rank, and a number of first columns of the one or more precoders previously identified in obtained uplink precoding information is related to the first PUSCH being transmitted, the number of first columns based on the rank.

Clause 81: The method of Clause 79, wherein the one or more codepoints indicate a column selection, and one or more columns of the one or more precoders previously identified in obtained uplink precoding information are related to the first PUSCH being transmitted, the one or more columns based on the column selection.

Clause 82: The method of Clause 79, wherein the TPMI indicates a codepoint of the one or more codepoints, the codepoint corresponding to a network entity-indicating wideband precoder, and the network entity-indicating wideband precoder is related to the first PUSCH being transmitted.

Clause 83: The method of Clause 75, wherein the uplink grant comprises a HR PI and an TPMI, the TPMI indicating one or more codepoints.

Clause 84: The method of Clause 83, wherein: the HR PI includes a value indicating that the TPMI indicates a rank, and a number of first columns of the one or more precoders previously identified in obtained uplink precoding information is related to the first PUSCH being transmitted, the number of first columns based on the rank.

Clause 85: The method of Clause 83, wherein: the HR PI includes a value indicating that the TPMI indicates one or more columns of the one or more precoders previously identified in obtained uplink precoding information, and the one or more columns of the one or more precoders previously identified in obtained uplink precoding information are related to the first PUSCH being transmitted, the one or more columns based on the column selection.

Clause 86: The method of Clause 83, wherein: the HR PI includes a value indicating that the TPMI indicates a wideband precoder to be applied for transmission, by a UE, of the first PUSCH, the TPMI indicates a codepoint of the one or more codepoints, the codepoint corresponding to the wideband precoder, and the wideband precoder is related to the first PUSCH being transmitted.

Clause 87: One or more apparatuses, comprising: one or more memories comprising executable instructions; and one or more processors configured to execute the executable instructions and cause the one or more apparatuses to perform a method in accordance with any one of Clauses 1-86.

Clause 88: One or more apparatuses configured for wireless communications, comprising: one or more memories; and one or more processors, coupled to the one or more memories, configured to cause the one or more apparatuses to perform a method in accordance with any one of Clauses 1-86.

Clause 89: One or more apparatuses configured for wireless communications, comprising: one or more memories; and one or more processors, coupled to the one or more memories, configured to perform a method in accordance with any one of Clauses 1-86.

Clause 90: One or more apparatuses, comprising means for performing a method in accordance with any one of Clauses 1-86.

Clause 91: One or more non-transitory computer-readable media comprising executable instructions that, when executed by one or more processors of one or more apparatuses, cause the one or more apparatuses to perform a method in accordance with any one of Clauses 1-86.

Clause 92: One or more computer program products embodied on one or more computer-readable storage media comprising code for performing a method in accordance with any one of Clauses 1-86.

Clause 93: A user equipment (UE), comprising: a processing system that includes processor circuitry and memory circuitry that stores code and is coupled with the processor circuitry, the processing system configured to cause the UE to perform a method in accordance with any one of Clauses 1-43.

Clause 94: A network entity, comprising: a processing system that includes processor circuitry and memory circuitry that stores code and is coupled with the processor circuitry, the processing system configured to cause the network entity to perform a method in accordance with any one of Clauses 44-86.

Clause 95: One or more apparatuses configured for wireless communications, comprising: a processing system that includes one or more processors and one or more memories coupled with the one or more processors, the processing system configured to cause the one or more apparatuses to perform a method in accordance with any one of Clauses 1-86.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors coupled to a transceiver and one or more memories coupled with the one or more processors, the processing system configured to:
obtain, from a network entity, a channel state information reference signal (CSI-RS);
transmit, via the transceiver, to the network entity, uplink precoding information that identifies a precoder that is based on the CSI-RS;
obtain, from the network entity, an uplink grant that indicates a selected precoder; and
transmit, via the transceiver, to the network entity, a first physical uplink shared channel (PUSCH) using the selected precoder.

2. The apparatus of claim 1, wherein the selected precoder is the identified precoder of the uplink precoding information.

3. The apparatus of claim 1, wherein the processing system is further configured to transmit, via the transceiver, a sounding reference signal (SRS) associated with the CSI-RS.

4. The apparatus of claim 3, wherein the SRS is quasi co-located (QCLed) with the CSI-RS.

5. The apparatus of claim 3, wherein the selected precoder is based on the SRS or the uplink precoding information transmitted by a user equipment (UE).

6. The apparatus of claim 1, wherein the uplink precoding information comprises at least one of wideband information or subband information.

7. The apparatus of claim 1, wherein to transmit the uplink precoding information, the processing system is configured to transmit a physical uplink control channel (PUCCH) or a second PUSCH, the PUCCH or the second PUSCH comprising the uplink precoding information.

8. The apparatus of claim 1, wherein the processing system is further configured to obtain, from the network entity, a configuration relating to transmitting the uplink precoding information, the configuration being based on a user equipment (UE) capability report.

9. The apparatus of claim 1, wherein the uplink precoding information comprises precoding matrix information.

10. The apparatus of claim 9, wherein the precoding matrix information comprises a precoding matrix indicator (PMI) mapped to a defined precoder within an uplink codebook.

11. The apparatus of claim 10, wherein the uplink codebook comprises a subset of a downlink codebook.

12. The apparatus of claim 10, wherein the uplink codebook comprises a codebook relating to one or more user equipment (UE) antenna architectures.

13. The apparatus of claim 9, wherein the precoding matrix information comprises a quantized or compressed version of an explicit precoder.

14. The apparatus of claim 1, wherein the uplink precoding information comprises a rank indication.

15. The apparatus of claim 1, wherein the uplink grant comprises an indication related to one or more precoders previously identified in transmitted uplink precoding information.

16. The apparatus of claim 15, wherein the indication related to the one or more precoders previously identified in transmitted uplink precoding information comprises at least one of:
rank selection information and a first modulation and coding scheme (MCS) corresponding to the rank selection information, or
column selection information and a second MCS corresponding to the column selection information.

17. The apparatus of claim 15, wherein the uplink grant comprises a transmitted precoding matrix indicator (TPMI), the TPMI indicating one or more codepoints.

18. The apparatus of claim 15, wherein the uplink grant comprises a high resolution precoding indicator (HR PI) and a transmitted precoding matrix indicator (TPMI), the TPMI indicating one or more codepoints.

19. An apparatus for wireless communications, comprising a processing system that includes one or more processors and one or more memories coupled with the one or more processors, the processing system configured to:
transmit a channel state information reference signal (CSI-RS);
obtain uplink precoding information that identifies a precoder that is based on the CSI-RS;
transmit an uplink grant that indicates a selected precoder; and
obtain a first physical uplink shared channel (PUSCH) using the selected precoder.

20. A method for wireless communications, comprising:
obtaining, from a network entity, a channel state information reference signal (CSI-RS);
transmitting, to the network entity, uplink precoding information that identifies a precoder that is based on the CSI-RS;
obtaining, from the network entity, an uplink grant that indicates a selected precoder; and
transmitting, to the network entity, a first physical uplink shared channel (PUSCH) using the selected precoder.
